(19) United States
(12) Patent Application Publication
(10) Pub. No.: US 2017/0046966 A1
(43) Pub. Date: Feb. 16, 2017

(54) Connected Learning Management System

(71) Applicants: Gregory Velasquez, San Jose, CA (US); David A. Vogt, Menlo Park, CA (US)

(72) Inventors: Gregory Velasquez, San Jose, CA (US); David A. Vogt, Menlo Park, CA (US)

(21) Appl. No.: 14/823,881

(22) Filed: Aug. 11, 2015

(51) Int. Cl. G09B 7/02

(52) U.S. Cl. CPC G09B 7/02

(57) ABSTRACT

A method of automating student and teacher workflow among an educational class of multiple students is provided. The method includes initiating, from a teacher-operated computing device, distribution of a class assignment data to multiple student-operated computing devices. The method includes receiving, at a database, from the multiple student-operated computing devices, student-provided assignment data, wherein the student-provided assignment data is accessible at the database by the teacher-operated computing device. The method also includes processing, but a computer processor, an evaluation by the teacher-operated device of the student-provided assignment data, wherein a grade for the evaluation of the assignment data for each of the multiple student-operated computing devices is further processed to organize the assignment data with regard to each student.

This application claims benefit of priority from U.S. Provisional Application No. 62/035,943 filed Aug. 11, 2014, which is hereby incorporated by reference.

### BACKGROUND

While digital tools for communications, organizing and resource sharing rapidly overtake traditional methods for tasks and activities in our social, professional and educational systems, many hurdles exist concerning their compatibility and interoperability, and thus often require users to operate these various tools independent of each other. These issues are exceedingly apparent and cumbersome in the educational arena, where many challenges exist to creating an organized process for educational administration that can be used across numerous different academic related institutions and for varying applications within those entities. Of the numerous different applications being developed and introduced to the marketplace to service various aspects of the educational industry in specific point solution formats, their simple adaption and interoperability across these many institutions that have differing data/IT infrastructures is prohibitive.

Some examples of the complex challenges that vary in nature, but otherwise are commonly found across many educational entities include but are not limited to, gaining access to scarce and coveted resources and funds for numerous competing needs in the public and private educational systems, organizing a nearly infinite variety of resources used for teaching, and various other aspects for administering the many participants involved in the educational process (educators, administrators, students and parents). Additionally, the many different academic institutions having various ranges of grade levels to administer within each, from pre-school to post graduate level in addition to supplemental education, and each have differing and often complex administrative systems and financial/funding mechanisms. This multitude of existing challenges contributes to the obstacles inhibiting the potential to simplify and streamline the existing organization and administration of the learning process, causing it to remain inefficient, complicated and frustrating.

### SUMMARY

Applicant has developed an innovative solution to address these problems. The Connected Learning Management System (CLMS) and method for educational organization, planning, administration, and learning enables each stakeholder in a person's educational program or process (EP), i.e. teacher/educator, student, parent, school administrator, participant (donor or recipient) in funding infrastructures, etc. to effectively organize necessary information, programs, resources and tools in a more efficient, consistent and simplified manner so that the education and learning process is optimized for efficiency and productivity.

The CLMS effectively connects and creates an organizational structure for the various paper and digital resources involved in the learning environment for access by all stakeholders. A digital platform enables the integration and bridging of the many various components that are used in the Educational Process (lessons, courses, resources, applications and point solutions) that have been otherwise previously inhibited for effective interoperability and organization.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of a system to automate teacher and student interactions, showing computing devices of administrators, teachers, students and parents coupled to a backend database via a server in accordance with some embodiments.

FIG. 2A is a flow and organizational diagram of workflow and interactions involving the backend database of FIG. 1 in accordance with some embodiments.

FIG. 2B is a block diagram of the organization of the backend database of FIG. 1, showing interactions among the backend database, student-operated computing devices, and a teacher-operated computing device in accordance with some embodiments in accordance with some embodiments.

FIG. 3 is a block diagram of a grades section of the backend database of FIGS. 1, 2A and 2B in accordance with some embodiments.

FIG. 4 is a flow diagram of teacher-student workflow for assignments in accordance with some embodiments.

FIG. 5 is a flow diagram of teacher-student workflow for tests or quizzes in accordance with some embodiments.

FIG. 6 is an example screenshot of a menu for a class, as seen on a teacher-operated computing device in accordance with some embodiments.

FIGS. 6A-D are the applications and features available through the menu of a teacher-operated computing device of FIG. 6 in accordance with some embodiments.

FIG. 7 is an example screenshot of a menu for the assignments of a class, as seen on a teacher-operated computing device in accordance with some embodiments.

FIG. 8 is an example screenshot of a menu for submitted work of a class, as seen on a teacher-operated computing device in accordance with some embodiments.

FIG. 9 is an example screenshot of a menu for a class, as seen on a student-operated computing device in accordance with some embodiments.

FIG. 10 is a flow diagram of a method of automating student and teacher workflow, which can be practiced using embodiments of the system to automate teacher and student interactions in accordance with some embodiments.

FIG. 11 is an example screenshot of the organization of Units, Sub-Units and Lessons arranged for a Class of Students within a Course in accordance with some embodiments of the present invention.

FIG. 12 is a diagram of the Organizational Management System and its systems of Timeline and Containers in accordance with some embodiments of the present invention.

FIG. 13 is a diagram of the features and flow of the Organizational Management System and Electronic Study Guide in accordance with some embodiments of the present invention.

FIGS. 14, and 14A-C is an example screen and description of the Electronic Grading Tool in accordance with some embodiments of the present invention.

FIGS. 15A-B is an example screen and description of the Class Builder Assignment Editor feature in accordance with some embodiments of the present invention.

FIGS. 16A-B is an example screen and description of the Smart Scheduler feature in accordance with some embodiments of the present invention.

FIG. 17 shows an overview and listing of the features in accordance with some embodiments of the present invention.

### DETAILED DESCRIPTION

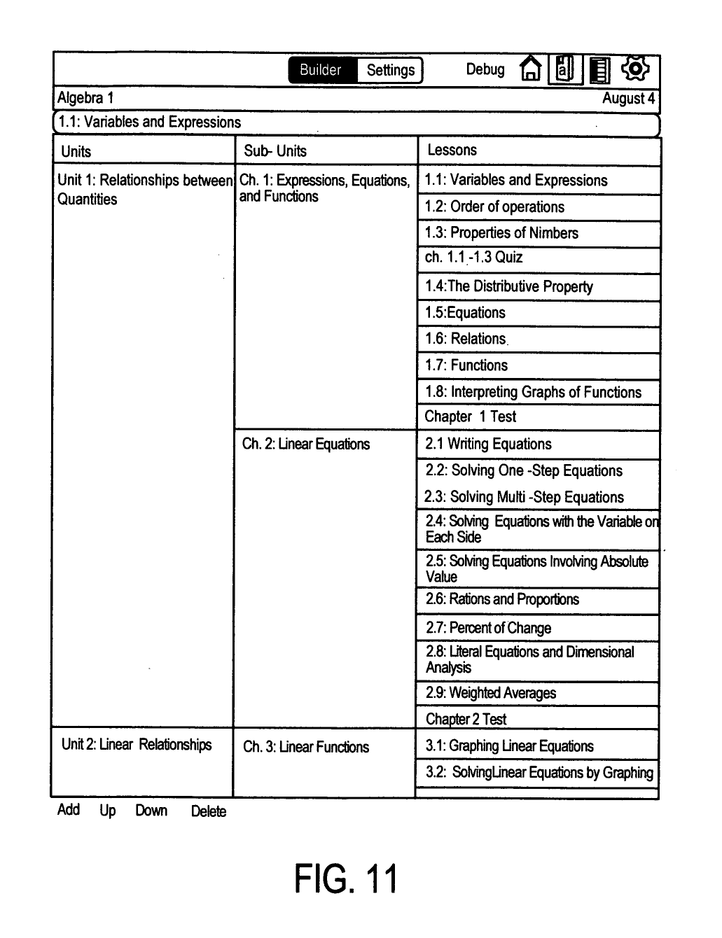

As described herein, certain features of the Connected Learning Management System “CLMS” are designated for a particular stakeholder, e.g. Educator, Administrator, Student or Parent, however it is understood that a feature may be useful to one or more others of the multiple stakeholders, for example, although the scheduling feature may be described for primary use by the Educator, the feature may also be useful for a student, parent or an administrator to use/access the feature during the EP, and therefore the designations are not intended to be exclusively limited, but instead illustrative and otherwise available to any person involved in the EP that may have a purpose for such feature. “Resources” are referred generally herein to include materials, data, notes; and “Assets” are more broadly referred to as including not only Resources, but also homework, assignments and tests or exams that are part of the Lessons and Classes that comprise the EP. A “Lesson” is the subject matter and resources that are used on a certain day or set of days toward a specific “Course”, and one or more Classes of Students may be taught the Course or even simply one or more Units within a Course. The Units and Sub-Units are the topics that make up the individual Lessons within a Course. For example, FIG. 11 illustrates the organization of the Course of Algebra 1, and the daily Lessons that get taught for that Class. Each Lesson is taught on a separate day, and the Resources and Assets for each Lesson are identified accordingly for convenient access by the CLMS within the OMS. A Unit pertaining to the Class may be, for example, “Relationships between Quantities” which is broken down further into Sub-Units, which may comprise both “Expressions, Equations and Functions” and “Linear Equations” within the Unit. For this example, the first Unit taught in a Course comprises two Sub-Units. The first Sub-Unit comprises ten Lessons, including eight topics for daily instructions, one quiz and one test. The second Sub-Unit also comprises ten Lessons, including nine topics for daily instructions and one test.

The user may have access to the CLMS via a web browser, in some embodiments. The user will also have access to the CLMS via Mobile App Versions for the embodiments on various types of portable electronic devices and computing devices now known, and to be developed, readily available to and used by teachers, administrators, parents and students. It should be appreciated that the orientations of the user interfaces may be Portrait or Landscape. It should also be appreciated that the CLMS app (as it is generally referred to in its user application via app or online through a web browser) can be used in an offline mode, and the data that is modified in the offline mode can later be synchronized with the CLMS once the CLMS and other app data is online.

Similarly, references used herein for certain features, functionality or visual cues are not intended to be limiting, for example, a button on a UI screen accessing a function or application represents access to a feature of the system or step in the process, and it is understood that the feature or step could be executed in other manners such as by voice recognition or other process known in the art or that will be developed as an extension of current technology. Further, intermediary steps could be included, or other applications or symbols that accomplish the same or similar functions may be used without limiting the inventions described herein.

Many different innovations comprise the Canary Learning Connected Learning Management System and method for organization, planning, administration, and management, of the educational process and system are described herein.

At the heart of the CLMS are three fundamental features that enable the interoperability and overall effectiveness of the system: a) a Workflow Management System, a) an Organizational Management System, and b) the CLMS Timeline.

These features enable other innovative features of the CLMS described herein, including the Smart Scheduler, the Electronic Grading Tool (EGT), the Electronic Study Guide (ESG), and the Reusable Course Organizer (RCO).

Other aspects of the CLMS include a calendar, planner, grade status, notification system, filing system, student workload status, forecast and other applications and features as described herein and as generally known in the art of Content Management Systems.

The Workflow Management System feature of the CLMS includes a system to automate teacher and student interactions, and a related method of automating teacher and student workflow, are herein disclosed. Interactions and workflow of teachers and students are automated and managed via a backend database, which is administered by a server. Class assignments, produced by teachers on teacher-operated computing devices, are placed into the backend database and distributed to the student-operated computing devices, so that the students can see the assignments. Students then produce student assignments on the student-operated computing devices, and place the student assignments into the backend database. Teachers can evaluate the student assignments, and place evaluations into the backend database. Students view the evaluations on the student-operated computing devices. Tests, distributed from the backend database, can be timed. Teachers can conduct discussions via the teacher-operated computing devices. Students participate in the discussions via the student-operated computing devices. Contents of the discussions are archived in the backend database. The backend database and the server could be part of a network, e.g., in a school or a school district, or could be provided as cloud services in some embodiments. The server could include a single computing device, or multiple computing devices, and a single memory storage, multiple memory storage or distributed memory storage. The related method can be practiced using the system to automate teacher and student interactions, and can be embodied on a tangible, computer-readable media.

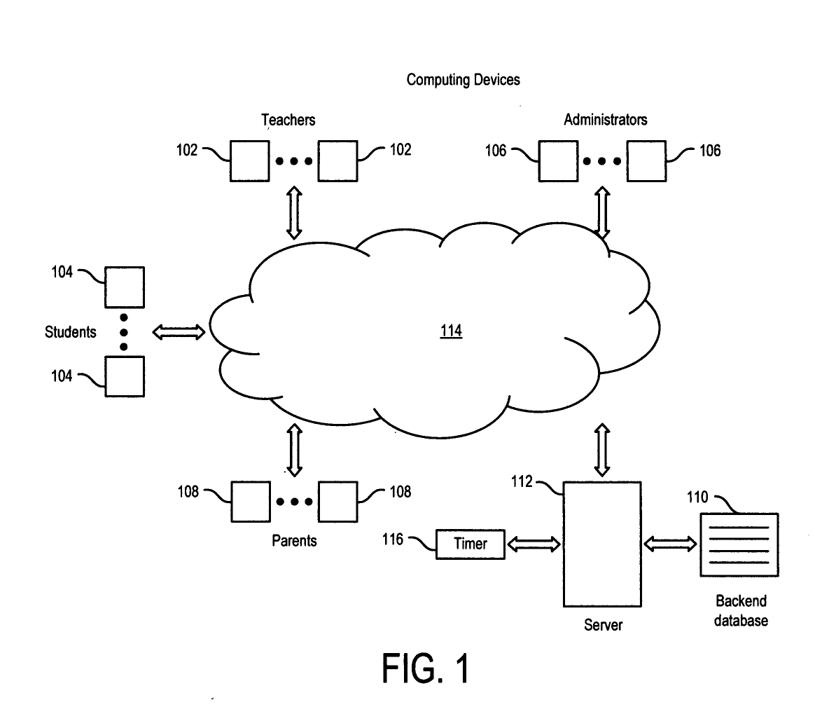

FIG. 1 is a block diagram of a system to automate teacher and student interactions, showing computing devices of administrators, teachers, students and parents coupled to a backend database 110 via a server 112. The server 112 is in communication with the backend database 110, and the server 112 is coupled to various computing devices 102, 104, 106, 108 via a network 114. In various examples, the network 114 could be a local network, a wide-area network, a wireless network, a global communication network such as the Internet, an intranet, etc. Administrator-operated computing devices 106 are used to set up and configure the system, via the server 112. These could be used by school officials and system administrators in some embodiments. Teacher-operated computing devices 102 are used by teachers to input and initiate distribution of the class assignments, to view and evaluate student assignments, and to input and initiate distribution of tests, via the backend database 110. Student-operated computing devices 104 are used by students to view the class assignments, to produce and submit student assignments, to view evaluations of student assignments, and to view tests and produce and submit test answers, via the backend database 110. A timer 116, to which the server 112 is coupled, is used in one embodiment for timing tests, i.e., for providing a timed interval used during testing of the students. Parent-operated computing devices 108 are used by parents to view various materials as appropriate to a class, and to interact with teachers, via the server 112 and the backend database 110. Class discussions can be coordinated via the server 112, with contents of the discussions archived to the backend database 110. Various embodiments of the system and method offer various combinations of the above-described features. Suitable computing devices include touchscreen computers, touchpad computers, personal computers, laptop computers, personal digital assistants, etc.

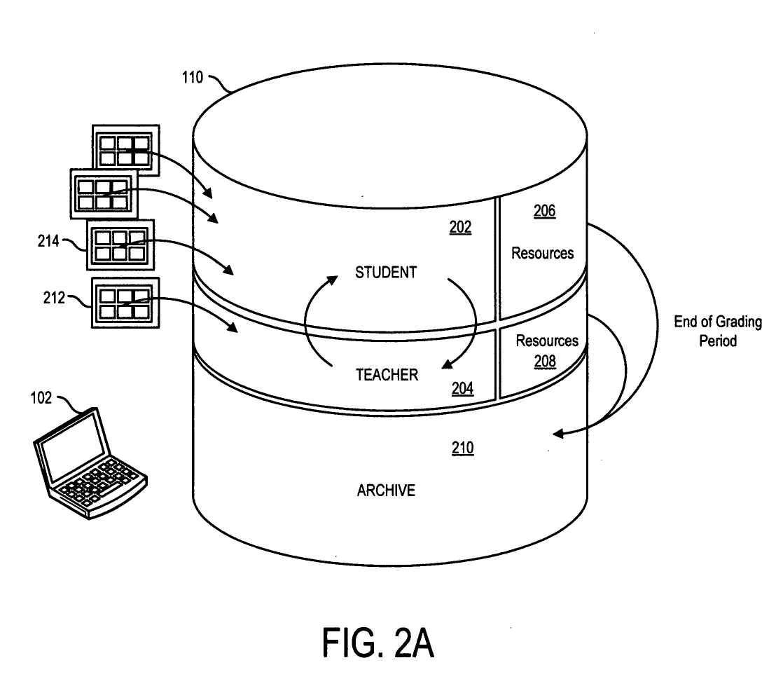

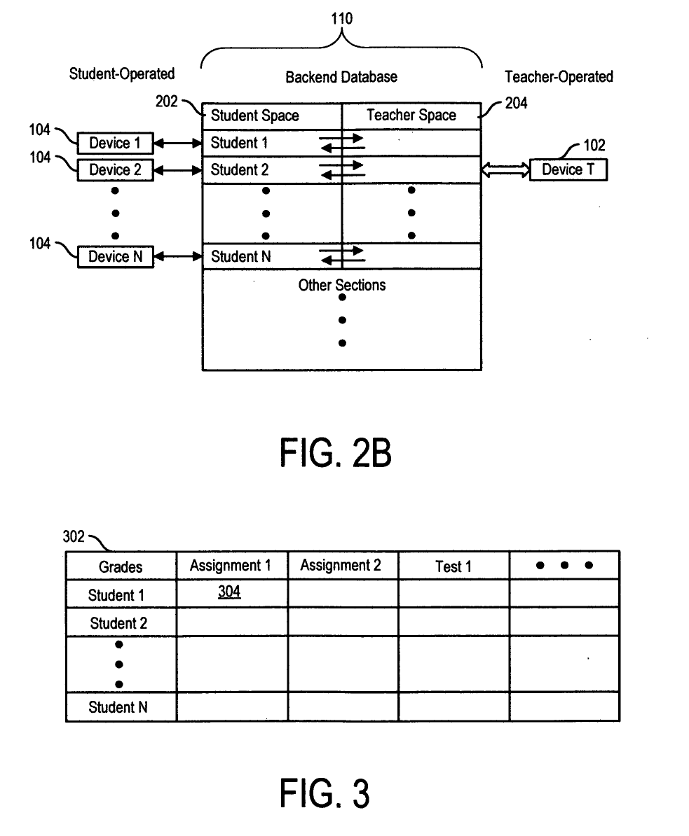

FIG. 2A is a flow and organizational diagram of workflow and interactions involving the backend database of FIG. 1. In the embodiment shown, the backend database 110 is partitioned or sectioned into student space 202, teacher space 204, and archive space 210, although further partitions could be added. A teacher views teacher-oriented graphical user interface items 212 on a teacher-operated computing device 102. The teacher directs workflow into the teacher space 204 of the backend database 110, as when depositing class assignments, evaluations of student assignments, class tests or evaluations of student test answers. Students view student-oriented graphical user interface items 214 on student-operated computing devices 104 (not shown in FIG. 2A, but see FIG. 1). Students direct workflow into student space 202 of the backend database 110, as when depositing student assignments or student test answers. The teacher, via the teacher-operated computing device 102, directs workflow from teacher space 204 into student space 202, as when distributing class assignments, class tests, evaluations of student assignments or evaluations of student test answers. Students, via student-operated computing devices 104, direct workflow from student space 202 into teacher space 204, as when submitting student assignments or student test answers. Teachers can contribute various class materials to a teacher resources space 208, which could be in or associated with teacher space 204. Teachers can move class materials from teacher resources space 208 to student resources space 206, which could be in or associated with student space 202. At the end of the grading period, the various materials can be moved from student resources space 206 and teacher resources space 208 into archive space 210. Further flow directions, materials, actions, variations and embodiments are described below.

FIG. 2B is a block diagram of the organization of the backend database 110 of FIG. 1, showing interactions among the backend database 110, student-operated computing devices 104, and a teacher-operated computing device 102. It should be appreciated that FIG. 2B illustrates a configuration of the system and the backend database 110 for a single class in accordance with one embodiment. Further embodiments are configured for multiple teachers, multiple classes, multiple classes for each of multiple teachers, and various class sizes (i.e., numbers of students). Additional sections of the backend database 110 are configured for grades, as will be discussed below, and/or for class resources, calendars, parent-teacher interaction, administration, and further activities and associated resources.

In the embodiment shown in FIG. 2B, the backend database 110 is partitioned into student space 202 and teacher space 204. The student space 202 is accessible by the student-operated computing devices 104, and the teacher space 204 is accessible by the teacher-operated computing device 102. The student space 202 and the teacher space 204 are partitioned on a per-student basis, for example having a section in both student space 202 and teacher space 204 for each of students 1 through N. This could be set up or populated by entering student information into the backend database 110 (e.g., via a teacher-operated computing device 102 or an administrator-operated computing device 106), or by importing a class roster (i.e., a list of students attending a class). Student space 202 can be configured to allow for more than one student-operated computing device 104 for a specified student, for example if a student operates one computing device at home and a differing computing device in a classroom, or multiple computing devices at a location. Teacher space 204 can be configured to allow for more than one teacher-operated computing device 102 for a specified teacher, for example if the teacher operates one or more computing devices in the classroom and one or more computing devices at home or in an office. As a further example, multiple teacher-operated computing devices 102 could be used when more than one teacher is teaching the class or providing materials for the class and each teacher has one or more teacher-operated computing devices 102.

Still referring to FIG. 2B, details concerning how the backend database 110 is applied to automate teacher and student interactions involving an assignment are provided, in one embodiment. The teacher creates a class assignment on the teacher-operated computing device 102, and sends or transfers the class assignment from the teacher-operated computing device 102 to the teacher space 204 of the backend database 110, via the server 112. The teacher-operated computing device 102 has read and write access to the class assignment in the teacher space 204, as provided by the server 112. Thus, the teacher can produce or edit the class assignment in teacher space 204, or can pull a local version of the class assignment back to the teacher-operated computing device 102 for editing, and return the edited version back to the teacher space 204. In one embodiment, the server 112 supports use of the teacher-operated computing device 102 in an off-line mode, e.g., to work on the class assignment or on evaluating student assignments, with the teacher-operated computing device 102 decoupled from the backend database 110. When the teacher-operated computing device 102 is back online, and coupled to the backend database 110 as by the server 112, the server 112 synchronizes the teacher-operated computing device 102 and the backend database 110, so that both the teacher-operated computing device 102 and the backend database 110 have the latest versions of the class assignment and other data as discussed further below.

When the teacher finishes producing the class assignment, the teacher initiates, from the teacher-operated computing device 102, distribution of the class assignment to the student-operated computing devices 104. The server provides, to the student-operated computing devices 104, read-only access to the class assignment, which resides at the backend database 110. In various embodiments, this can be accomplished by moving the class assignment onto a calendar, which resides in a class resources section of the backend database 110, or moving a read-only version of the class assignment into student space 202 of the backend database 110, or sending the class assignment in an email or a message to the student-operated computing devices 104. In any of these mechanisms, the students have read-only access and cannot modify the class assignment residing at the backend database 110. As with all moves of data discussed herein, it should be appreciated that moving data can include sending a copy of the data while preserving the data at a location in the backend database 110 in some embodiments.

Students, upon viewing the class assignment, produce student assignments using the student-operated computing devices 104. In the embodiment shown, each student-operated computing device can have read and write access to a student-specific workspace in student space 202, for working on files, documents, data etc. in draft mode. The server 112 and the backend database 110 support operation of the student-operated computing device 104 in an off-line mode, with the student-operated computing device 104 decoupled from the backend database 110. When the student-operated computing device 104 is back online, and coupled to the backend database 110 as by the server 112, the server 112 synchronizes the student-operated computing device 104 and the backend database 110.

When the student finishes producing the student assignment, the student submits the student assignment, which moves the student assignment from student space 202 to teacher space 204. In one embodiment, this may be accomplished by converting the student assignment from read and write form, as was maintained in draft mode in student space 202 with read and write access by the student-operated computing device 104, to read-only form or a read-only version of the student assignment. The read-only form or version of the student assignment is placed in teacher space 204. In a further embodiment, the teacher-operated computing device 102 has read-only access to the student assignment, in teacher space 204 of the backend database 110. In one embodiment, the conversion is one-way, and the read-only version of the student assignment can be viewed by the student-operated computing device 104 in student space 202 as a finalized submission of the student assignment, which is no longer editable by the student.

The teacher then has read-only access to the student assignment, in teacher space 204. Next, the teacher can evaluate the student assignment, using the teacher-operated computing device 102. In one embodiment, the student assignment is converted to portable document format (e.g., PDF format), which prevents any editing. However, in one embodiment, the teacher-operated computing device 102 is set up so that the teacher can apply markups over the student assignment, for example to apply a grade and/or comments to a student-provided document as converted to the portable document format. While the teacher is working on evaluation of the student assignment, the teacher may have read and write access to the markups of the document in teacher space 204 of the backend database 110. As above, the teacher-operated computing device 102 can work in off-line mode, and synchronize upon reconnection to the backend database 110. In both online mode and off-line mode followed by synchronization, the evaluation of the student assignment originates on the teacher-computing device 102 and moves to the backend database 110.

When the teacher completes evaluation of the student assignment, the evaluation of the student assignment is moved from teacher space 204 to student space 202, for each student. For example, the evaluation of the student assignment could be converted to read-only form and placed in the specified student section of student space 202, or a copy of the evaluation of the student assignment could be made available for read-only access by the student-operated computing device 104, at the backend database 110. It should be appreciated that quizzes and tests can be similarly administered, with each quiz or test distributed in a similar manner to a class assignment, and the test answers gathered much as the student assignment. However, in further embodiments, features are added supporting timed interval tests as described below. The timer 116, from FIG. 1, is used by the server 112 to provide a timed interval for the test.

Continuing with FIG. 2B, the teacher provides the class test from the teacher-operated computing device 102 to the backend database 110. As with class assignments, the teacher-operated computing device 102 can have read and write access to the class test in a draft mode in teacher space 204, and can work off-line and then synchronize with the backend database 110 when coupled. The teacher initiates, from the teacher-operated computing device 102, distribution of the class test to the student-operated computing devices 104. The server 112 and the backend database 110 provide read-only access, for the student-operated computing devices 104, to the class test. This could be accomplished by providing a read-only version of the class test in student space 202, or in a class resources section of the backend database 110.

The timer 116 is started upon distribution of the class test. As a practical matter, the timer 116 could be started just slightly before or just slightly after the class test is distributed. Students produce test answers using the student-operated computing devices 104, in a manner similar to producing student assignments. The student-operated computing devices 104 are coupled to the backend database 110, via the server 112, and the student-provided test answers reside in student space 202 with read and write access during the test, in one embodiment. In a further embodiment, the student-operated computing devices 104 can work off-line, but may couple to the backend database 110 in order to submit the test answers, which could be by selection at the student-operated computing device 104 or by synchronizing.

In one embodiment, the students submit their test answers from the student-operated computing devices 104 by so indicating prior to expiration of the timed interval at the timer 116. Student-provided test answers are retrieved from the student-operated computing devices 104 upon expiration of the timed interval, in one embodiment. Student-provided test answers are accessible, with read-only permission, at the backend database 110 by the teacher-operated computing device. One manner that this can be accomplished is by moving the test answers from student space into teacher space upon expiration of the timed interval. That is, since the student-provided test answers originate on the student-operated computing devices 104, the test answers are retrieved or collected from the student-operated computing devices upon expiration of the timer or other indication of the end of the test. The test answers are retrieved or collected by any or a combination of the students submitting the test answers, the server 112 pulling the test answers, moving the test answers from student space 202 into teacher space 204, and/or converting the student answers from read and write access by the student-operated computing devices 104 to read-only access by the teacher-operated computing device 102.

In one embodiment, there is a test cheat-prevention feature. The server notifies the teacher-operated computing device if one of the student-operated computing devices performs a copy operation on any or all of the class test data during the test. This feature could be implemented using keystroke or function monitoring on the student-operated computing devices, or trapping a screen capture operation or other relevant copying operation on the student-operated computing devices. The notification could take the form of a message sent to the teacher-operated computing device, or a posting in teacher space 204. Evaluation of the student-provided test answers proceeds similarly to the evaluation of the student-provided assignments in some embodiments. Marked up test answers can be moved from teacher space 204 to student space 202. Students can view the evaluations of the test answers using the student-operated computing devices 104, with read-only access to the evaluations of the test answers at the backend database 110.

FIG. 3 is a block diagram of a grades section 302 of the backend database 110 of FIGS. 1, 2A and 2B. The grades section 302 is partitioned per student and per assignment in some embodiments. Thus, there is an evaluation section 304 for a grade and/or comments for each assignment for each student. Further arrangements for the grades section 302 are readily devised. In one embodiment, the grades section is exportable from the backend database 110, so that the grades and/or comments can be used for other applications or databases. Particularly, exporting the grades section 302 could be used for production of report cards or transcripts. In one embodiment, the evaluation sections 304 across the assignments, tests and quizzes, for a specified student, have read only access by the student at the backend database 110. In further embodiments, these could be visible by parents using the parent-operated computing devices 108. It should be appreciated that some schools, particularly with alternative programs, apply comments only and no grades. In such a case, it is understood that the comments serve as, or serve in place of, grades.

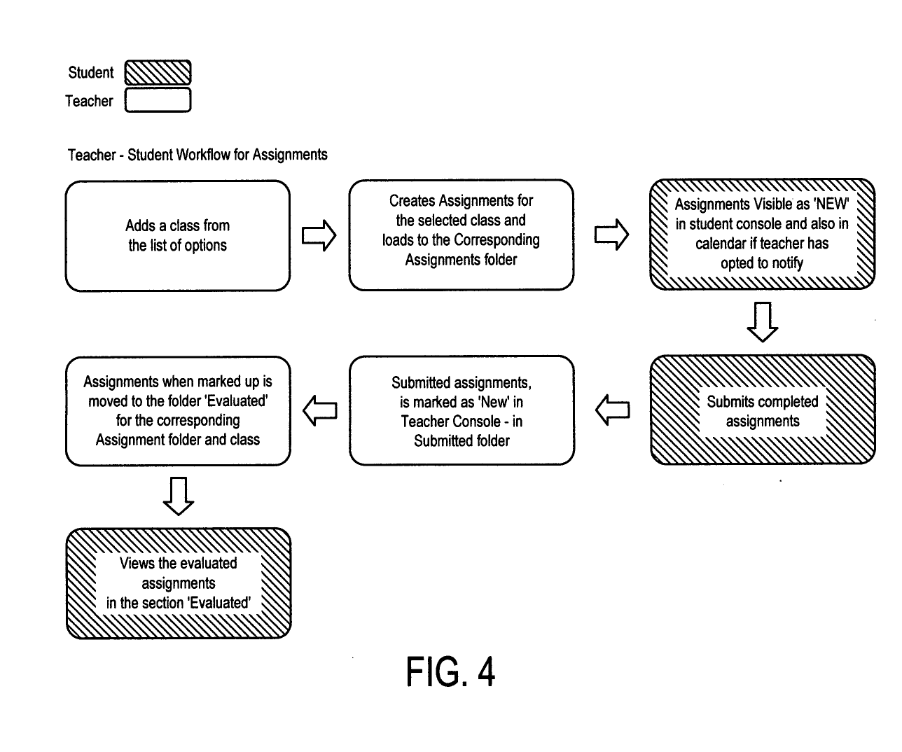

FIGS. 4-9 relate to examples of user interfaces, mechanisms, features and operation of various embodiments. It should be appreciated that the backend database 110 could include multiple databases, and the server 112 could include multiple servers, in implementations of various combinations of these.

Embodiments described herein create an educational application (i.e., app) for the kindergarten through 12^{th} grade environment, as well as for college and graduate school environments that automates the interaction of functions between student and teacher. Versions may be developed for a specified operating system environment with a specified computing device as the main end-user device due to availability, popularity and market presence within the target user group. Particularly, versions could be developed that employ specially programmed student-operated computing devices, specially programmed teacher-operated computing devices, and/or a specially programmed server. The system provides a classroom workflow application that for example: stores data, assigns work to students and turns in data. Teachers mark up the data received using the application, and teachers file the grades using the application. Various embodiments may achieve the following:

Automation in the distribution of assignments, homework and tests

Automation on the feedback on assignments, homework and tests

Repository for past student and teacher data

Calendar of assignments, homework, tests

Group Discussion

Class Resource Folder

The backend CMS (Content Management System, e.g., a specially programmed server coupled to the backend database) is for the use of:

The app (application) administrator who will be adding and managing multiple school accounts;

The individual school administrator who will be managing the classes and the teacher and student users of that school.

Additionally, the user will also have access to the application via a web browser, in some embodiments. It should be appreciated that Backend CMS may be optimized and tested for various browsers, such as: INTERNET EXPLORER; FIREFOX; CHROME and SAFARI.

Mobile App Versions for the embodiments described herein may be developed and integrated into the system. Computing devices refer to computing devices readily available to and used by teachers and students. It should be appreciated that the orientations of the user interfaces may be Portrait or Landscape. It should be appreciated that the app can display saved data in offline mode and synchronize with the CMS and other app data online.

Assignments and tests created by teachers can be in various file formats (they may contain references to the Resource Area, which can have files in other formats). In one embodiment, all submitted work will be in PDF format. PDF markup tools could be used for doing the assignments, evaluating/grading them, etc. Completing the assignments/tests, evaluating & grading, etc. are supported within the app (and, in one embodiment, are not downloadable for edit and upload). It is possible that the Student/Teacher may not complete an assignment or finish grading a test in one session. Therefore, the assignment/grading session can be saved (e.g., in draft mode) and worked on at a later date, in one embodiment.

In some embodiments, each school year's data may be moved to an automatically created folder within the app account and can be accessed from the folder when required. Alternative data archiving features for the students and teachers are readily devised.

All user data will be received in the backend CMS in some embodiments. The resources, quizzes, assignments, submitted and graded assignments/quizzes, etc. are synchronized across app accounts as required. This data/file/folder structure is designed so that both students and teacher have access to the same document at any time with their own respective databases. A super administrator has the ability to manage the details of all schools registered in the system. Super administrators can assign modules to the schools, create/activate/deactivate school accounts, etc. School Administrator can manage all the Teacher and Student accounts of the school, manage the documents, portfolio, etc. The school administrator can set access privileges on the modules the teachers and students can access. Teachers can create and load classes, upload assignments, grade assignments submitted by students, create a quiz, add notes, update the calendar on the upcoming events, add resources, etc. Students can access the classes created by teachers, access assignments, submit assignments, view their own graded assignments, view shared resources, update the calendar, etc.

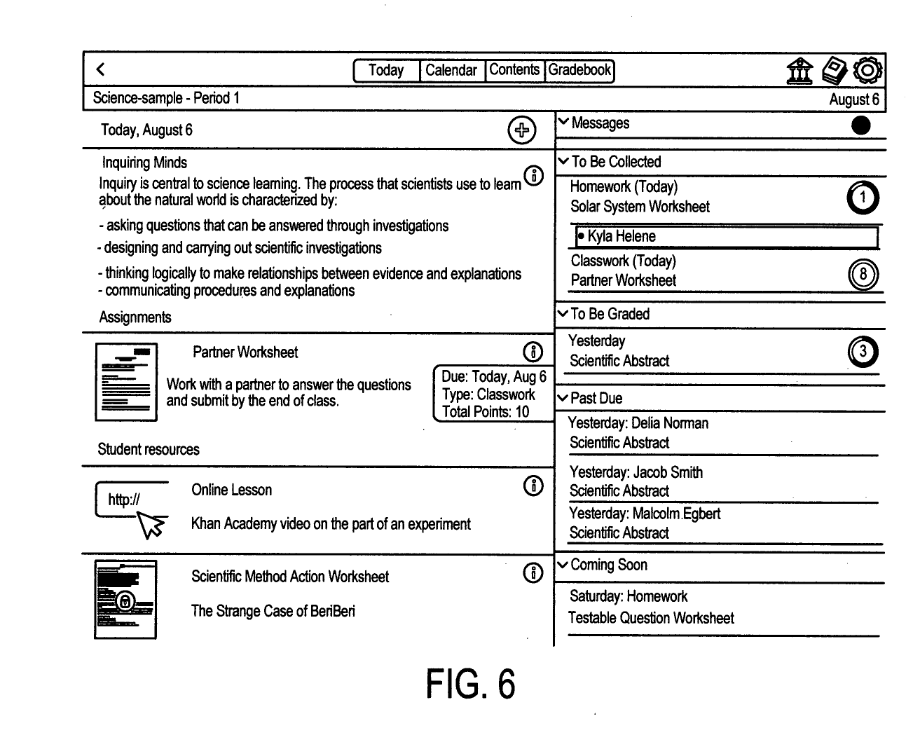

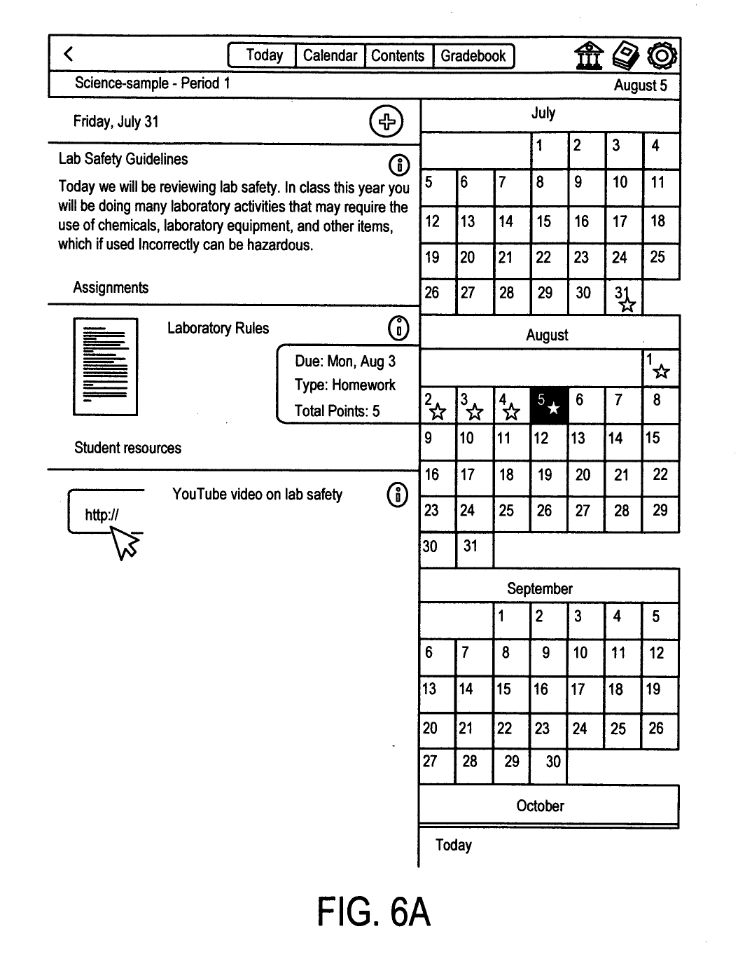

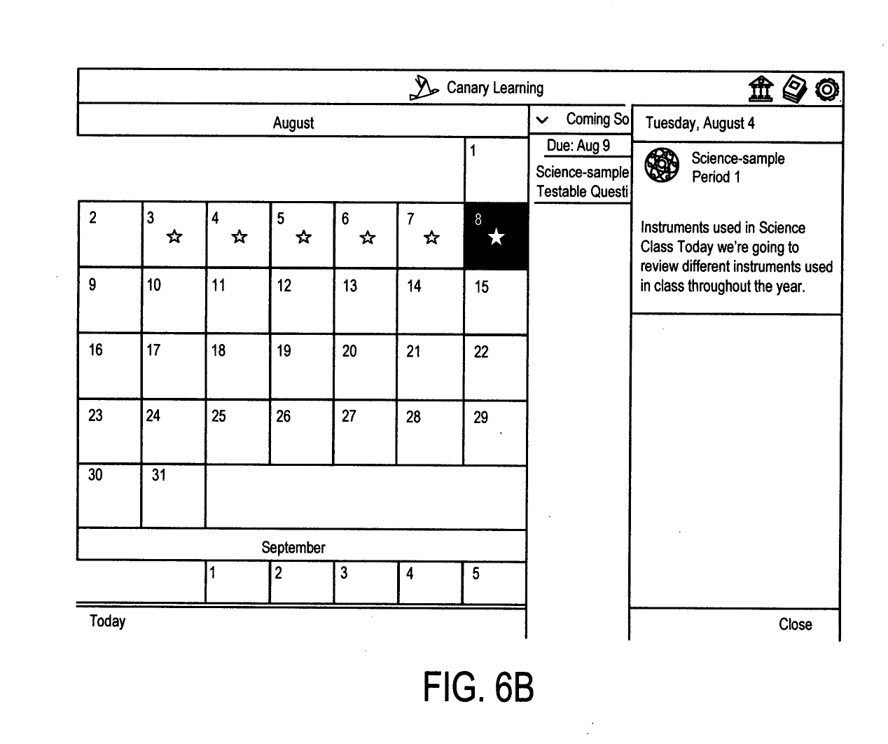

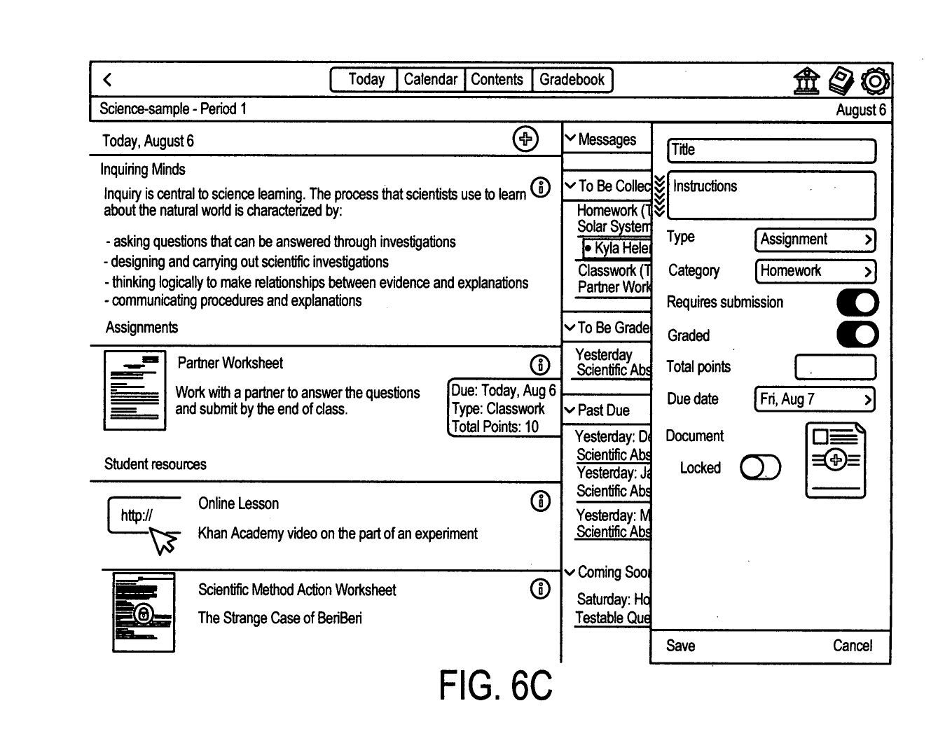

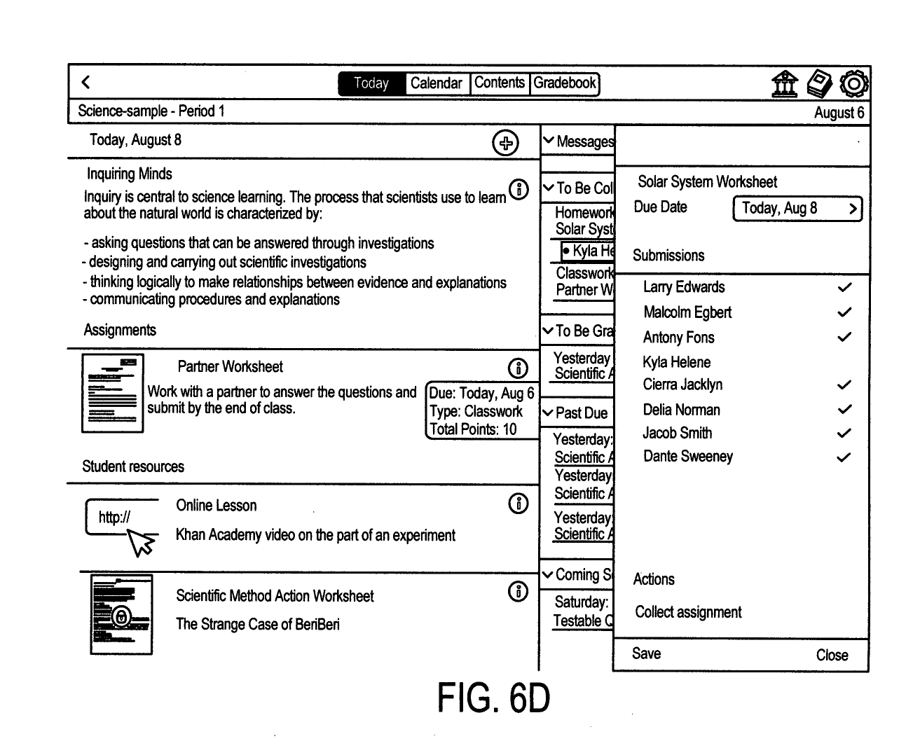

FIG. 4 is a flow diagram of teacher-student workflow for assignments. The teacher adds a class from the list of options. This can be performed on a teacher-operated computing device 102, by selecting items from one or more menu screens, with the server 112 configuring the backend database 110 accordingly. A sample menu for managing assignments for a physics class, as seen on the teacher-operated computing device number 102, is shown in FIG. 6, which will be further discussed below.

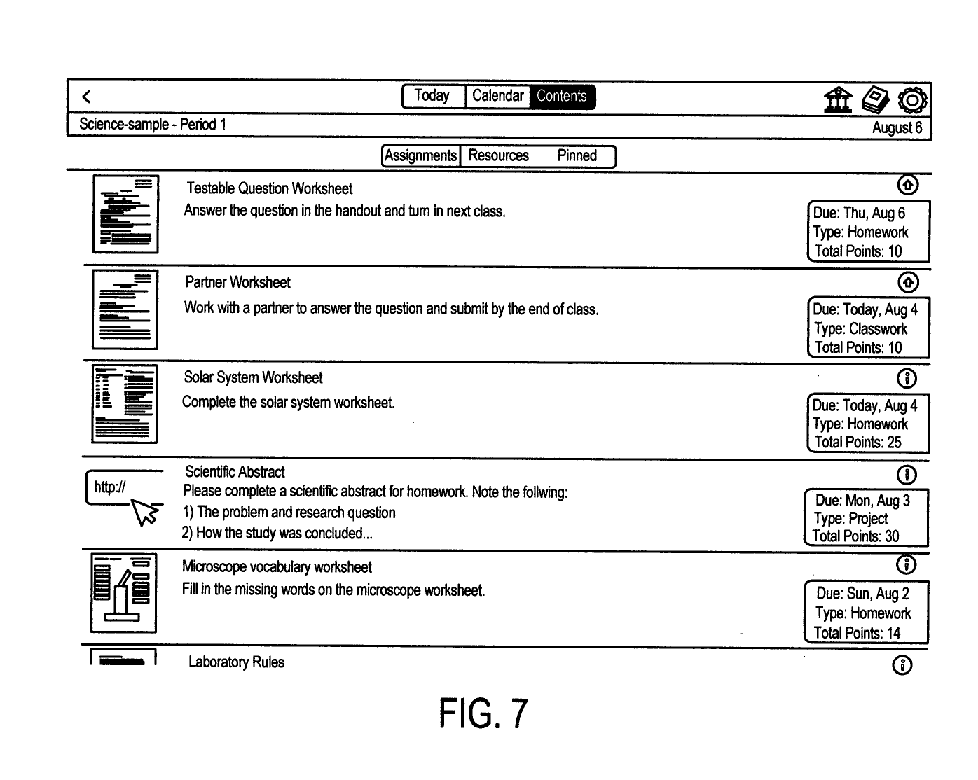

Continuing with FIG. 4, the teacher creates assignments for the selected class and loads the assignments to the corresponding assignments folder, as shown in FIG. 7. This can be performed on the teacher-operated computing device 102, using a graphical user interface, with the assignments going to the backend database 110. As shown in FIG. 4, the assignments are visible to the students as “new” in the student console, i.e., on the student-operated computing device 104, and also in a calendar (which is maintained on the backend database 110), if the teacher has opted to notify the calendar.

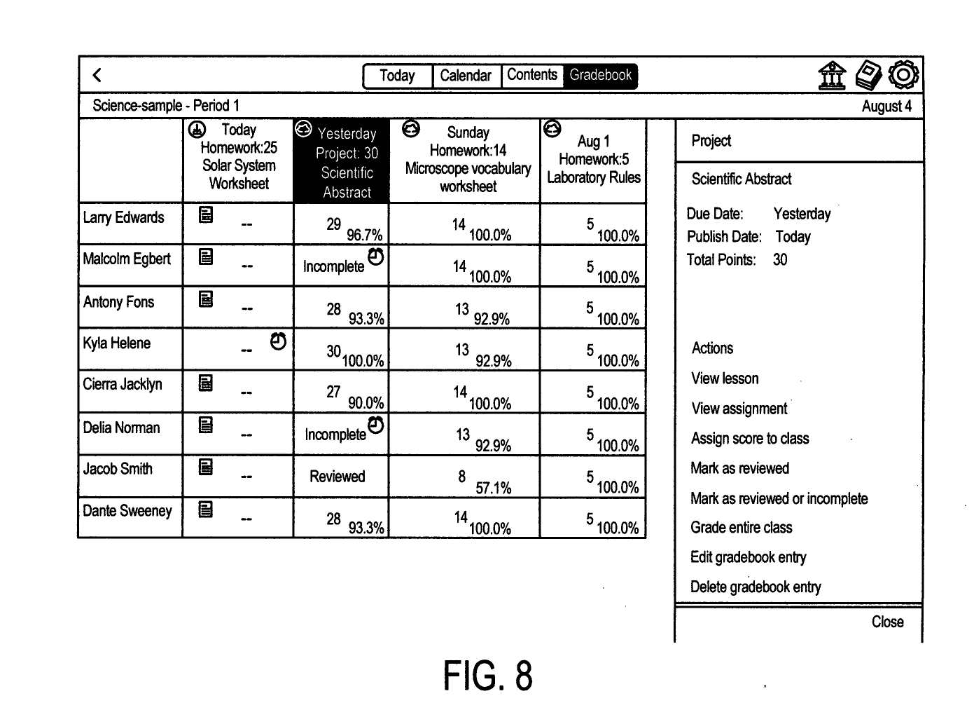

The students submit the completed assignments. Students can perform these actions on the student-operated computing devices 104, with the assignments submitted to the backend database 110. The submitted assignments are marked as “new” in the teacher console, i.e., in the teacher-operated computing device 102. For example, the assignments could appear on the teacher-operated computing device 102 in a folder labeled “submitted” as shown in FIG. 8.

Continuing with FIG. 4, assignments, when marked up, are moved to the folder “evaluated” for the corresponding assignment folder and class. For example, the evaluations of the assignments could appear on the teacher-operated computing device 102 in a folder labeled “To Be Graded” as shown in FIG. 6. As mentioned above, for an assignment, or a discussion, the teacher can add a resource such as a pointer to a video, a pointer to a webpage, or actual video content, documents, or other data to a shared class resource section of the backend database 110. The students can then view these resources, via access to the backend database 110. In the case of a discussion, the teacher can start and moderate a discussion from the teacher-operated computing device 102. The students can respond to the discussion, using the student-operated computing devices 104. Contents of the discussion can be archived to a section in the backend database 110 in some embodiments. The discussion could have the general form of a chat room, with membership limited to the teacher and students registered for the class.

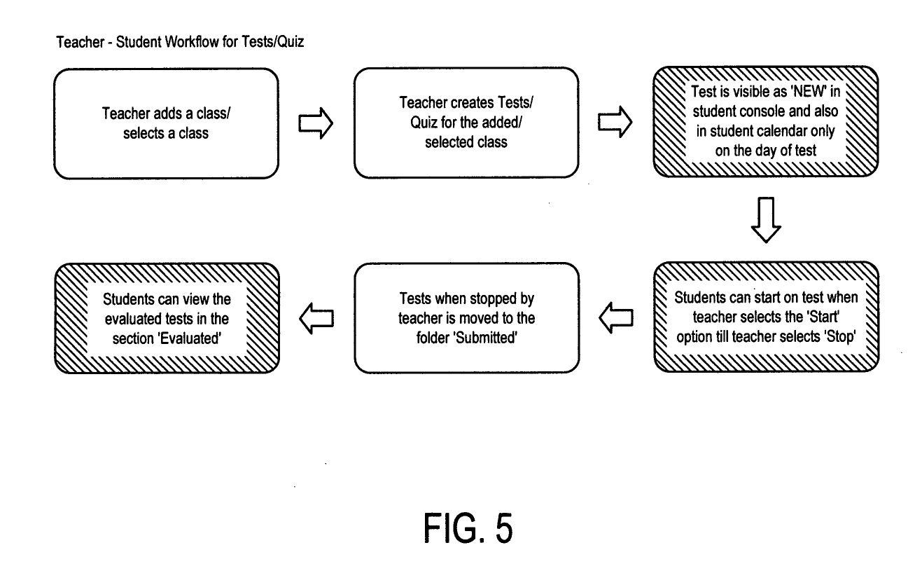

FIG. 5 is a flow diagram of teacher-student workflow for tests or quizzes. The teacher adds a class or selects a class. This can be performed on a teacher-operated computing device 102, as discussed regarding FIG. 4. The teacher creates tests or quizzes for the added or selected class. This can be performed on the teacher-operated computing device 102, in a manner similar to creating assignments. The test or quiz goes to the backend database 110. The test or quiz is visible as “new” in the student console, i.e., on the student-operated computing device 104, and also in the student calendar. The test is visible for a limited period of time, such as only on the day of the test in some embodiments.

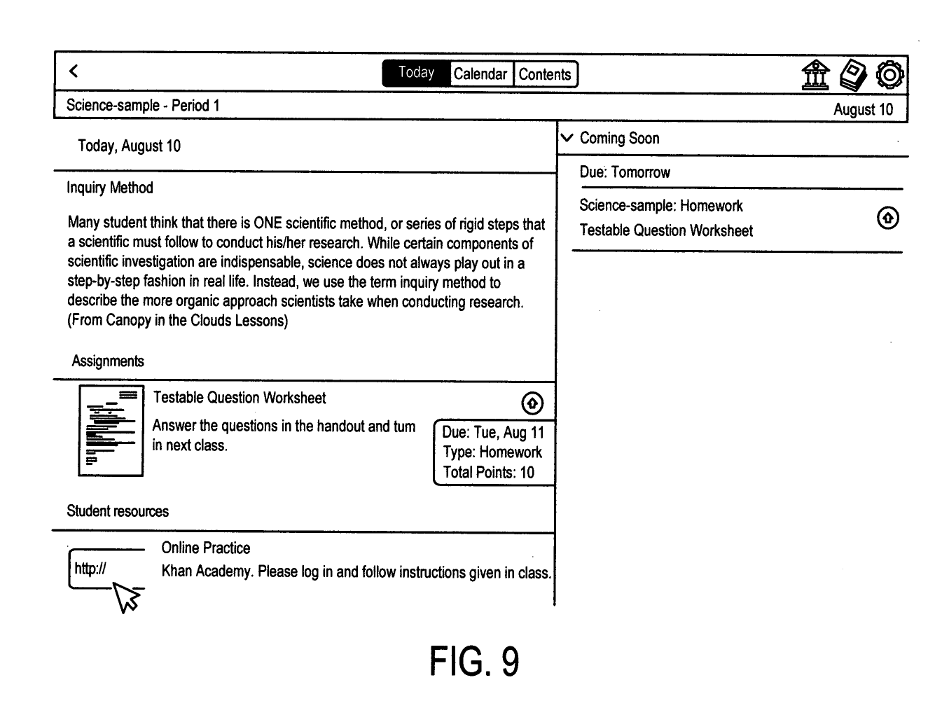

Students can start on the test when the teacher selects the “start” option, and can work on the test until the teacher selects the “stop” option, i.e., the test is for a timed interval or at least an interval that is at the discretion of the teacher. In a further embodiment, the system makes use of the timer 116 to automate the timed interval of the test. When stopped by the teacher, the tests are then moved to the folder labeled “submitted”. This could be the folder shown in FIG. 8, or a separate folder just for tests or quizzes. Students can view the evaluated tests in the section labeled “evaluated”. This could be the student version of the folder shown in FIG. 9, with tests sorted accordingly.

The following descriptions are functional specifications of the embodiments of various features. Menus, dialog boxes and other aspects of a graphical user interface suitable for these functions, and variations thereof, are readily devised in accordance with the teachings disclosed herein.

The Super administrator of the app can log in to the system using the User Name/Email ID and password provided. There could be a Reset Password option in some embodiments. The access for the first super administrator of a newly installed app is coded and provided. Thereafter this administrator can log in, and change access details as well as add other super administrators (if required). All super administrators have the same privileges and rights in some embodiments.

A log out button and a link to open “My Profile” section are provided in all pages after logging in, in some embodiments. The left navigation bar of the user interface lists the menu options for the logged in user in some embodiments. Clicking on any of the menu options opens the list view for that section displaying the already saved data. From here, the user can proceed to manipulate existing data (Actions—View, Update & Delete) or add new information.

The main menu options for the Super Administrator in some embodiments are:

Manage administrators, Manage schools, Manage data, and Manage portfolio.

The details are explained in the sections below:

Super administrators can manage details of the selected schools, for example activate/deactivate/delete/edit all school and school admin accounts in some embodiments. In other embodiments, the different functionalities of each role are maintained as separate modules. For example, “Assignments” for teachers as well as students will constitute a module. Another example is “Resources”. The objective is to allow more flexibility when considering the specific requirements of different schools. Only those modules required by a certain school are provided and configured accordingly.

At the end of each Grading Period, all the data belonging to that year can be moved for the students and teachers into an archive folder on the app. This functionality could be configured to occur automatically. At the beginning of the new school year, the sections for classes, assignments, tests, etc., are empty and ready for the year's work. Thereafter, the user can go to the specific school year's archive folder and retrieve a specific file. A grading period can be specific to each school.

The super administrator can initiate the creation of archive folders corresponding to each school year. The details saved for each folder are, for example—folder name, description and the start/end dates for the particular school year. The folder is automatically created in the app for each user account. Once the end date has elapsed, all the files which were created on the app in that date range are automatically moved into this folder, for each user account. These folders are available in the Portfolio section of the app (for the teacher and the student). The super administrator can edit all profile details such as First & Last Name, Username, password etc.

Schools can register and add users to enable them to use the app. When a user registers, a User Name and Password is emailed to the registered email id, which the user can change later. After log, a user can manage school details as appropriate. A school admin can add additional school admins to the system and edit/delete their account details. School admins will add classes and students and edit/delete classes and students (as well as their details).

An example of a class is “Physics”. The same class may be taught to different sets of students at different times, e.g., “Physics 101—10 AM”. The school administrator can create all the classes in the backend database 110 so that the classes are available as options in the app, and the students and teachers can select their classes on the app. School administrator can add teachers to the system. They can edit/delete/activate/deactivate teacher accounts.

The teacher or an administrator handles the initial system setup, and the terms are used interchangeably for purposes of explanation of features and their access. Students, teachers, and classes can be added by the administrator. Students can be added to each class by the administrator. Teachers can be added to classes by the administrator. School administrators can add students to the system and assign classes to students. School administrators can edit/delete/activate/deactivate student accounts. The system will initially generate the username and password for students. In some embodiments, provision is given to add multiple classes for each student for different school years. Teachers can log in to the app using the school ID, User Name/Email ID and Password provided. There will be a Reset Password option which will send the reset password link to the saved registered email address.

Examples of various screens are given below. The main menu options are provided in the left navigation bar. The top menu bar on every screen displays the Back button, Refresh button and Settings option (which provides options such as—“My account” and “Log out”). Vertical scrolling is enabled. It should be appreciated that the various graphical user interface items and variations thereof could be implemented using webpages, screens, menus, folders, pop-ups, etc.

A teacher can add a class by selecting from a list of classes. Teacher will often teach the same class to different students at different time slots. For example, there could be a teacher teaching Physics 101 at 9 AM, Physics 101 at 10 AM, and Physics 201 at 11 AM. When “+” is tapped, in a new overlay, the list of all classes (not already taken by self/other teachers in the current school year) are displayed in some embodiments. The teacher can select one by one and add a class to the teacher's own schedule. Alternatively, this could be done as the administrator, as discussed above.

FIG. 6 is an example screenshot of a menu for a class, as seen on a teacher-operated computing device 102. As shown in FIG. 6, for a class there is “Today's” date whereby a teacher can enter content for that day. Among the options for content to enter are: Assignments, Student Resources and Teacher Resources. The teacher adds the assignments by browsing and uploading data such as files or documents, e.g., in PDF format, from the teacher-operated computing device number 102 to the backend database 110, as shown on the screen of FIG. 6c. On the right hand side of FIG. 6 there is contextual information for teachers that could include: Messages, To Be Collected Assignments, To Be Graded Assignments, Past Due Assignments and Coming Soon Assignments. When students have submitted work for an assignment the “To Be Collected” component where the number displays how many students have yet to submit the assignment to the teacher. FIG. 6A is an example screen shot of a calendar menu for a class, as seen on a teacher-operated computing device 102. As shown in FIG. 6A, for a class a teacher can pick any day whereby a teacher can enter content for this particular day chosen from the calendar. Among the options for content to enter are: Assignments, Student Resources and Teacher Resources. The teacher adds the assignments by browsing and uploading data such as files or documents, e.g., in PDF format, from the teacher-operated computing device number 102 to the backend database 110. Once content has been entered for a chosen day, a star will appear on the calendar for both teacher and student screens (FIG. 6B).

FIG. 6B is an example screen shot of the student home screen, as seen on a student-operated computing device. As shown in FIG. 6B, a star on a given day is displayed to represent content being entered by a teacher. Upon selecting a given day, a slide out will appear displaying the classes that have entered content for that day.

FIG. 6C is an example screenshot of a menu for entering content shown in the slide out on the right hand side. A teacher can enter a title, description; choose between an assignment, student resource or teacher resource. If a teacher chooses assignment they have options to pick the category of the type of assignment, e.g. homework. There is a toggle for whether the assignment requires a submission by a student and whether the assignment is graded. If the assignment is graded the teacher is required to put in the total number of points. The teacher also enters the due date and whether the document is locked or unlocked. The teacher can add any relevant content by browsing and uploading data such as files or documents, e.g., in PDF format, from the teacher-operated computing device number 102 to the backend database 110. FIG. 6D shows a screen where a teacher can view which students of a class have submitted their assignment due that day, and which students have not yet done so.

FIG. 7 is an example screenshot of a menu for the assignments of a class, as seen on a teacher-operated computing device. Students see assignments that are added by the teacher. The teacher adds the assignments by browsing and uploading data such as files or documents, for example, in PDF format, from the teacher-operated computing device number 102 to the backend database 110 from either the “Today” (FIG. 6) or “Calendar” (FIG. 6A) screen. For each assignment, the teacher can set Date and Time of when it is due, and select whether to lock the content from being viewed by a student (FIG. 6C). When students (who have enrolled for that class) login and open the class home page, as shown in FIG. 6, new assignments are shown on the home screen. Any resources attached to an assignment by the teacher are also available to the student in the Assignment folder. Once the teacher creates a new assignment for a class, the assignment appears on the student console under “Assignments”.

FIG. 8 is an example screenshot of a menu for submitted work of a class, as seen on a teacher-operated computing device. Students complete an assignment, and when they submit the assignment, the assignment shows up in the Teacher console, for example, on the teacher-operated computing device 102, under “Gradebook” as shown in FIG. 8. The “Gradebook” page displays all student documents or other data for given assignments. When a student submits a student-provided assignment, the assignment is date stamped. If the assignment is submitted later than the due date, the student-provided assignment is marked with an icon to indicate the work was “Past Due”.

FIG. 9 is an example screenshot of a menu for a class, as seen on a student-operated computing device 104. As shown in FIG. 9, for a class there is “Today's” date whereby a student can view content for that day. Among the options for content to view and interact are: Assignments, Student Resources and Upcoming events or assignments. The student can access the assignments by opening the relevant attached files or documents from the teacher, e.g., in PDF format, that the teacher added through the teacher-operated computing device number 102 from the backend database 110 (FIG. 6C).

It should be appreciated that screens, menus and so on seen on the student-operated computing devices could have appearance and arrangements similar to and related to the screens, menus and so on seen on the teacher-operated computing devices. Further embodiments are described below.

Only Assignments that have been marked up are included in the Gradebook, visible through the UI in some embodiments. All assignments and tests will be moved from this “Evaluated” type folder in the database, after every grading period in other embodiments. These materials are moved to the respective grading period's Portfolio, or “archive” type folder. Creating Tests/Quiz follows a similar process as creating assignments. The teacher can post tests to a calendar but students cannot see the actual test until the day of test.

The teacher-operated computing device 102 has a screen or other graphical user interface area with a Start and Stop function. The teacher starts a test and only then the test becomes active, i.e., accessible from the backend database 110 to the student-operated computing devices 104, and the students can work on the test. When teacher stops the test, students can no longer work on the test. When the test is stopped, the test shows up in “Submitted” to be marked up. Once evaluated by the teacher and submitted for transfer back to the student, the file, i.e., the evaluated student-provided test answers, is moved to the “Evaluated” folder.

Each class has its own discussions. Only a teacher can add a discussion in some embodiments. Students can respond to discussions. An example layout for a discussion has a header at the top, which remains there throughout the discussion, even as entries to the body of the discussion scroll. In the header, the teacher can enter a discussion title, a question for discussion, or a statement for discussion, etc. Below the header, the student responses and teacher responses are posted as entries in order as they arrive, and these scroll upwards as new responses join at the bottom. Scrolling is enabled on each computing device, so that if a student or teacher wishes to review earlier parts of the discussion, she or he may do so individually.

Resources could include various types of files or links to files, such as YOUTUBE videos, avi files, video files, presentations and scanned documents, e.g. in PDF format. The teacher can add/delete resources. The teacher can also add resource links to Assignments. New assignments, and tests, when created will be marked in the calendar automatically and will show up in the student calendar if selected. The teacher screen 102 and student screen 104 could have complementary buttons for live or pre-taped instruction or selected presentations designed to accommodate remote instruction.

Students can log in to the app using the User Name/Email ID and Password provided. There can be a Reset Password option. Students can view classes to which they are assigned. Students can view, within each class, the assignments, tests, resources and discussions for that particular class. For each class, the student has access to the following sub menus:

Assignments Submitted Evaluated Test/Quiz Discussions Resources

Tapping open the Assignments menu will display the list of pending assignments to the student user. These are the assignments for which the student is yet to submit the work. Any new assignments given by the teacher (since the last log in by this student) are indicated by means of a badge display on the “Assignments” sub menu option icon. The number of new assignments is displayed here in vivid red color, for example. If the teacher (while creating an assignment) also checked the option to indicate the assignment on the calendar then the assignment will show up on the calendar for that particular date. If the teacher added resources related to a particular assignment, then those resources are also available here to open and view.

Each assignment file can be opened by the student, worked on and saved as a draft (if it is not yet ready to be submitted). Files can also be imported to the app via attachments in email or a network-based file drop off/retrieval service, e.g. DROPBOX (for example, an assignment that was partially worked on, on a separate device, on the laptop etc.). Once the submit status is set, the item is moved to the “Submitted” folder/section.

Submitted

The completed and submitted assignments are available in this section. The student can open and view them but not edit.

Evaluated

Students can view the evaluated assignments and tests. Any new assignments/tests evaluated by the teacher (since the last log in by this student) are indicated by means of a badge display on the “Evaluated” sub menu option icon. The number of new items is displayed here in, for example, a vivid red color. Each file can be opened and the comments made by the teacher viewed. The comments are not editable by the student.

Tests/Quiz

Quizzes and tests have a similar flow to that of assignments. The difference is that only when teacher selects “Start”, the student can start working on the test. When the teacher selects “Stop”, the students can no longer work on the test.

View and Respond to Discussions

Students can view the discussion created by teacher and respond to these discussions (Students cannot start a discussion in some embodiments).

View Resources

Students can view the resources added by their respective teachers for the various assignments. New resources can also be added by the student. Resources can be in various formats, such as PDF files, audio or video files.

View Calendar Updates

The new assignment and test calendar updates will be shown here if selected so by the teacher.

View/Edit Profile

Students can edit their own profile details.

The following business rules are adhered to by some embodiments. Each student should be able to access information and files of only the classes assigned to that student. This includes the events on the calendar. Calendar notifications created by the student are for the student's own view only and should not be viewable on anybody else's calendar. Once students submit assignments/tests, they should not be allowed to edit/submit the same again. Students should not be able to continue on a Test once the teacher selects Stop. Discussion comments added by students cannot be edited/deleted.

The app can be used only when online, in some embodiments. In offline mode, only the data saved locally when last online would be accessible locally, i.e., on a respective student-operated computing device 104 or teacher-operated computing device 102. Any actions done when offline are synchronized with the CMS and other accounts/devices only when the device goes online the next time. Data is synchronized with two-way syncing of the backend CMS and the mobile app.

Data Repository: Student and teacher could each have their own data repository. In one embodiment, these are implemented in student space 202 and teacher space 204, in the backend database 110. The data repositories may have a similar structure to Windows file/folder formats. The same file may reside in Teacher and Student databases in different folders and with differing labels.

The teacher picks or creates the assignment (PDF, text whether pages, word, entered via a dialog box, etc., video, audio, or other format, with any added links) and loads it through the web browser or computing device app to the Teacher Repository, which is part of the backend repository, which in turn is part of the backend database 110. For example, the Teacher Repository could be implemented in teacher space 204. The teacher then can pick the file from the Teacher Repository and load it. The teacher picks date/calendaring options and posts the assignment.

The student will be notified of this assignment in the calendar within the app (if selected by the teacher) or in the “Assignments” Module is a “New” listing. At this point the student opens the Assignment (which could be a document in PDF format) and reads the assignment. The student then works on the assignment.

The student can pick any text editor (this can be outside of the app) and work on the assignment. The student can work on the document and (a) save it locally on the student-operated computing device 104 (e.g., with no network connection) and synchronize to the Student Repository (on part of the backend database 110) later or (b) save the file directly to the Student Repository (e.g., using a network connection). The student can complete the assignment at a later date—when the assignment is completed the student saves the assignment (e.g., as a document in the PDF format) to the Student Repository. Then, (from within the app) the student can go to the “Assignments” Module and submit the assignment.

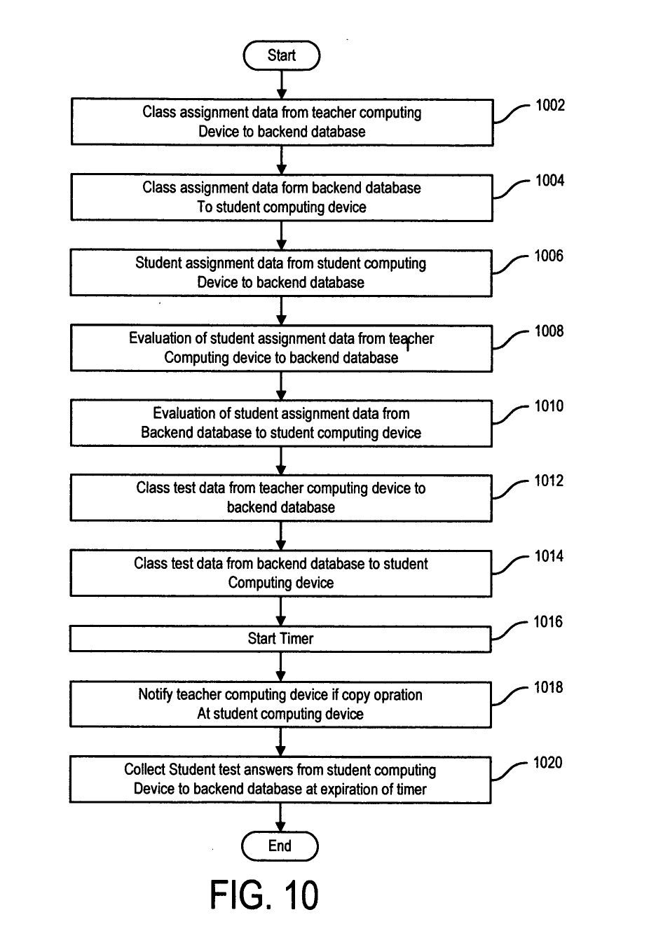

FIG. 10 is a flow diagram of a method of automating student and teacher workflow, which can be practiced using embodiments of the system to automate teacher and student interactions. It should be appreciated that when movement of data is described, this could include various formats, copies, conversions from one format to another, or even extractions of data or subsets of data. For example, moving student assignment data from one place to another could involve copying the student assignment and placing a copy of the student assignment in the new location, or converting the student assignment from one format to another and placing the converted version in the new location while leaving the original version in the former location, and so on. As a further example, collecting student test answers could involve moving the test answers data, copying the test answers data, converting the test answers data, extracting test answers data from a larger set of input data and so on. From a start point, the method proceeds as below.

Class assignment data goes from a teacher computing device to a backend database, in an action 1002. For example, the teacher could provide the class assignment from a teacher-operated computing device to the backend database directly, or through editing sessions and synchronizing. Class assignment data goes from the backend database to a student computing device, in an action 1004. For example, the teacher could initiate distribution of the class assignment by submitting the class assignment, via the backend database. The class assignment is then visible to the student-operated computing device, via the backend database, in a folder or in a calendar, or both.

Student assignment data goes from the student computing device to the backend database, in an action 1006. For example, the student could be creating or editing the student assignment using a workspace in student space in the backend database. Alternatively, the student could create or edit the student assignment locally on a student-operated computing device, then synchronize the device to the backend database upon connection. When the student submits the student assignment, the student assignment moves from student space to teacher space in the backend database.

Evaluation of student assignment data goes from the teacher computing device to the backend database, in an action 1008. For example, the teacher could access the student assignment data using a teacher-operated computing device. The teacher could then evaluate the student assignment, e.g., by using a markup application and the teacher-operated computing device, and applying comments and a grade onto the otherwise read-only version of the student assignment. The teacher then places the marked up version of the student assignment, i.e., the evaluation of the student assignment, in the backend database either directly or through off-line editing followed by synchronizing upon connection. The evaluation of the student assignment is moved from teacher space to student space in the backend database.

Evaluation of the student assignment data goes from the backend database to the student computing device, in an action 1010. For example, the student could access the evaluation of the student assignment by using a student-operated computing device to access the student space in the backend database. The student-operated computing device has read-only access to the evaluation of the student assignment, at the backend database.

Class test data goes from the teacher computing device to the backend database, in an action 1012. For example, the teacher could create, edit or otherwise provide the test, using the teacher-operated computing device, and move the test from the teacher-operated computing device to the backend database either directly or through off-line editing followed by synchronizing upon connection.

The class test data goes from the backend database to the student computing device, in an action 1014. For example, the teacher could initiate, from the teacher-operated computing device, distribution of the test. The teacher could do so by pressing the “start” button (e.g., a soft button on a graphical user interface) on the teacher-operated computing device. Once initiated, the server provides to the student-operated computing device a read-only access to the test at the backend database, so that the test can appear on the student-operated computing device. For example, the test could be moved from teacher space to student space in the backend database.

In an action 1016, a timer is started. In various embodiments, this could be a timer communicating with the server, a timer operated by the teacher, an ad hoc timer such as a classroom clock (which is already running but is considered to start the timed interval of the test), or even the teacher's innate sense of when to start and stop the test. It should be appreciated that not all embodiments require an actual timer, but that some embodiments have one. In an action 1018, the teacher computing device is notified if a copy operation occurs at a student computing device. It should be appreciated that not all embodiments have this action, but that some embodiments do. This could be implemented through keystroke monitoring or operation trapping, and/or situational analysis of the student-operated computing devices, with oversight by the server. The server could then send a message to, or otherwise notify, the teacher-operated computing device.

The student test answers are collected (or retrieved) from the student computing device to the backend database at expiration of the timer, in an action 1020. This could occur in response to an automated timer, associated with the server, reaching a specified interval endpoint, or in response to the teacher pressing a “stop” button (e.g. a soft button in a graphical user interface) on the teacher-operated computing device. The test answers could be collected by student submission, e.g., by pressing a “submit” button on a student-operated computing device. Or, the student-operated computing device could be placing the test answers from the student-operated computing device into the backend database all along during the test, and the endpoint of the test interval results in the backend database ceasing to receive further answers past the endpoint of the test interval. In a further embodiment, the student test answers are collected at an indication to stop the test. Such an indication could come from the teacher-operated computing device, or the server, or a timer coupled to the server.

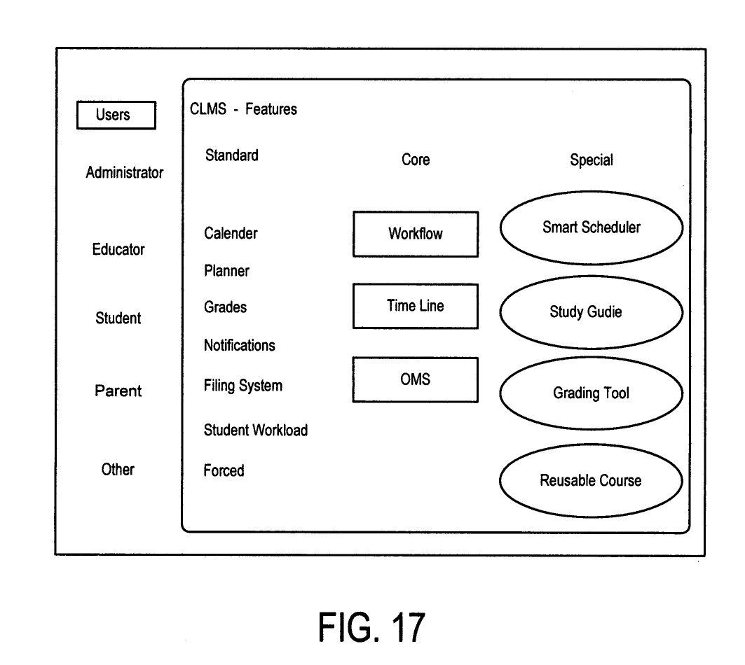

Within this framework, the Organizational Management System (OMS) of the Connected Learning Management System “CLMS” is an innovative feature that enables Educators and Administrators to create and organize Courses within Applicant's CLMS system and application. The OMS accomplishes this function through an organizational structure of Units, Concepts, and Lessons, and the CLMS provides a system for these to be organized digitally with respect to the relevant materials (Resources and Assets) to be then accessible by Educators, Administrators and Students through a combination of Lesson Containers, organizational tools, and date relative Assets. Many innovative features of the CLMS are enabled by the OMS, as listed on FIG. 17 and described herein.

To describe the structure and function of the OMS, we can begin with a description of the Course. The Course is where Educators create their organizational structure for the Classes they teach. As shown in FIG. 11, a Course is broken down into Units and Sub-Units that are referred to by Educators to determine the topics and daily Lessons they will teach for the Course. For each Course Educators sometimes teach certain Units, Sub-Units or Lessons within one Course in other Courses, Lessons are used by Educators to prepare for a Course and to ensure distribution of relevant materials (Assets) to Students in a Class that are signed up, assigned or registered to take that Course. Similarly, certain Lessons, Units or Sub-Units within a Course may overlap with and be used in other Courses. For example, as shown in FIG. 11, an Educator may teach a Course of Algebra 1, and may access the Unit of “Linear Relationships” in a different Course of Geometry taught to a separate Class. Once Educators have organized Courses and their respective Lessons within the OMS, the daily materials can be effectively distributed to Students within Classes taking those Courses.

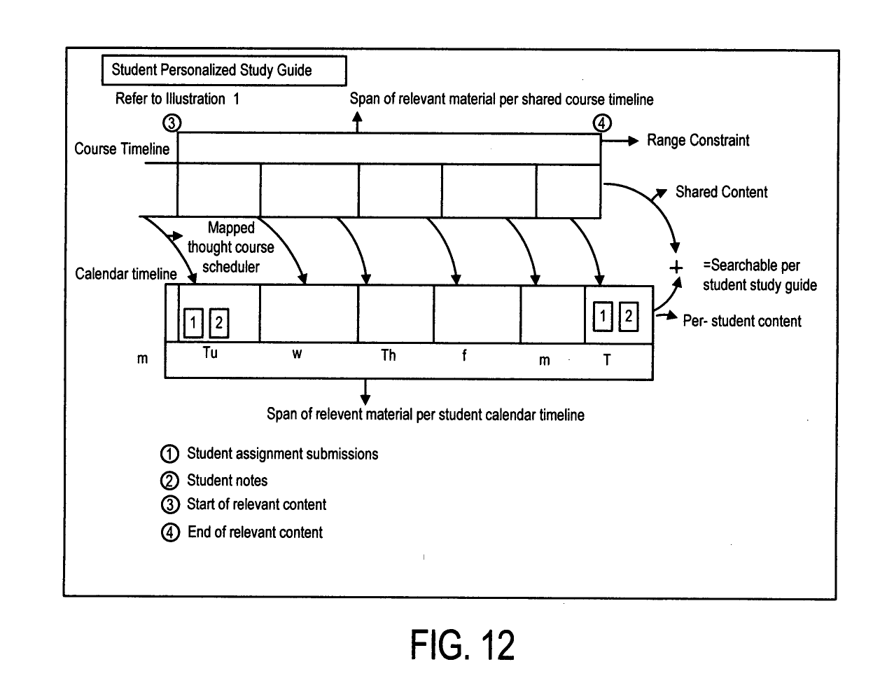

FIG. 12 illustrates how the OMS ties the system database components and materials and resources of CLMS that are relevant to their Educational Activities.

The OMS provides a system for Assets to be organized digitally and then accessible by Educators, Administrators and students through a combination of Lesson Containers, organizational tools, and date relative Assets. The OMS' Containers allow the Educator to designate individual Assets and then to bundle those Assets in one or more Containers. A Lesson could be included in a bundle for a specific Course, and can also be placed within one or more other bundles for other Courses. This method and system for bundling Resources in Lesson Containers alleviates the need to recall materials from memory or rely on less-than-optimal manually generated filing systems for such material. The Educator can simply pull a bundle of related material from an organized structure for consideration of an upcoming Lesson or Course rather than each individual Resource from various file storage locations.

A curriculum map or guide (CG) is an organizations' structure that becomes familiar to Educators for Course and Lesson preparations and scheduling. The respective Assets for each Lesson and Course are easily accessible throughout the CLMS features described herein through this organization. The OMS uses the structure of the CG to break a Course down into Units, and then break the Units further down into Concepts or Sub-Units. Lessons are created based on the topics to be taught within this structure of Sub-Units that comprise Units that comprise Courses. Each Concept determines the specific Resources useful for a particular Lesson. The Concepts are then grouped into the higher level Unit or topic (Lesson or Class) to which they are relevant. By presenting the CG in a graphical visual form to the Educator or other user, the relevant Resources are more effectively presented, and the ability for the Educator to access and organize a comprehensive set of Assets (material for the Course) is simplified through the process of Drag and Drop of Lessons. Once the Lessons are dropped onto the CG, the CLMS Smart Scheduler places them in the appropriate calendar dates, the those designated for Student access are then viewable by Students assigned to the Class to be instructed that Lesson(s). The Lessons are also accessible to the Students through the Electronic Study Guide feature of the CLMS. The Smart Scheduler and Electronic Study Guide are further described below.

Within the CG, the Units/Lessons and Concepts are ordered, establishing a defined order for the Lessons included. The user is able to track the position in the Timeline of Units they are preparing for upcoming, current or past Lessons, so that the next Lesson(s) in the sequence of the Timeline can be anticipated. This organizational structure enables an Educator to easily access a Lesson and follow or modify the order of Educational Activities for that Lesson (e.g. skip certain topics, reorder and/or modify Lessons) that prior curricula has followed to prepare for each Lesson in a course.

Through such structural management, the lessons that become irrelevant can more productively be managed and either ignored (if they have already been taught or for some reason they are chosen to be skipped), removed (if the lesson has become obsolete or has been already replaced), or updated/edited to become relevant to the lesson and course.

Once a Unit, Concept, and Lesson is accessed by an Educator and identified as part of the Timeline associated with a curriculum and Course, the process of editing a prior version's content or constructing a new Lesson from various parts or all of previously used Lessons is inherently simplified, and the Educator can more readily focus on the substantive educational matters rather than the organization aspects of the associated tasks. The entire outline of a Course, and the prior versions of Course Lessons enable the Educator to effectively and productively modify and use specific Lesson details such as material to be taught, Assets to be distributed, and assignments to task.

Each Lesson constitutes a Container. The Lesson Container holds Resources and Assets (e.g. handouts, assignments, and notes) that will be used for a day of a Course (or a set of days). That Lesson Container can be modified per its use in a Class and is the primary driver in the scheduling system.

Each Lesson Container, as referenced as 2 within a course timeline referenced as 1 in FIG. 12, can be simply considered as a daily lesson plan that can be modified at any time for each specific Course being taught. One or more Lesson Containers may be appropriate for a particular Course and Class. For each Lesson that is created, inputted or modified by the User (Educator or Administrator) within the CLMS, an associated tag or identifier, in addition to a brief description of the Lesson, is added. The description helps the Educator recall detail about the Lesson and Class to which it is assigned, as well as helps the Student who is signed up for or is taking a Course for which these Lessons and Classes pertain. Any Asset that has been identified with a particular Lesson becomes organized and available to an Educator to use for preparation for a Lesson and Assets associated with the Lesson that are those designated for Student access are made available to Students in the Class. “Resources” are referred generally to materials, data, notes; and “Assets” are more broadly referred to as Resources, in addition to Assignments and Test or Exams.

The OMS Lesson Containers are also used for accessing Assignments and Tests, referenced in FIG. 12 as 5, and then editing and grading, and distributing graded Assignments and Tests by the Educator via the CLMS Electronic Grading Tool (EGT). The OMS and EGT provide a tool to view many aspects of a Students' Class status, including whether Assignments were completed, whether completed on time, and if an Assignment has yet been graded by the Educator and if so, a display of their individual and collective grades for a Class and for an EP. For example, if a Student has yet to turn in an Assignment due on a particular day, it will be included in the “To Be Collected” component of the CLMS User Interface (UI) dashboard for each of the Student and Educator and Parent, and once an Assignment is turned in by the Student (and/or collected by the Educator) it is immediately displayed as “Collected”, or if it remains uncollected, will show as a “Past Due” display.

Containers are the foundation for the OMS and organizational capacity of the CLMS, the Containers allowing for the Educator to designate individual Assets and then to bundle those Assets for storage and access by the Educator. This method and system for bundling Resources and Assets in Containers alleviates the need to recall materials from memory or rely on less-than-optimal manually generated filing systems for such material. The Educator can simply pull a bundle of related material from an organized structure for planning or other consideration of an upcoming lesson or course rather than each individual Resource and Asset from various file storage locations.

The CLMS OMS enables several additional innovative features that, through their effective system integration, enable a more efficient, productive and seamless manner for stakeholders in the educational process to organize, plan, administer and learn as part of an educational program or process. The Timeline, referenced as 1 in FIG. 12, is the feature that ties Resources and Assets that are tagged or identified and stored within the OMS Containers to each of the functions of the CLMS that include scheduling and planning features, including the Smart Scheduler and Electronic Study Guide. Integrated throughout the CLMS is a system to dynamically generate a guide for students to organize and access the myriad of resources and information needed for scheduling, planning and preparing for the various Educational Activities and tasks related to their Lessons, Courses, and overall educational curriculum.

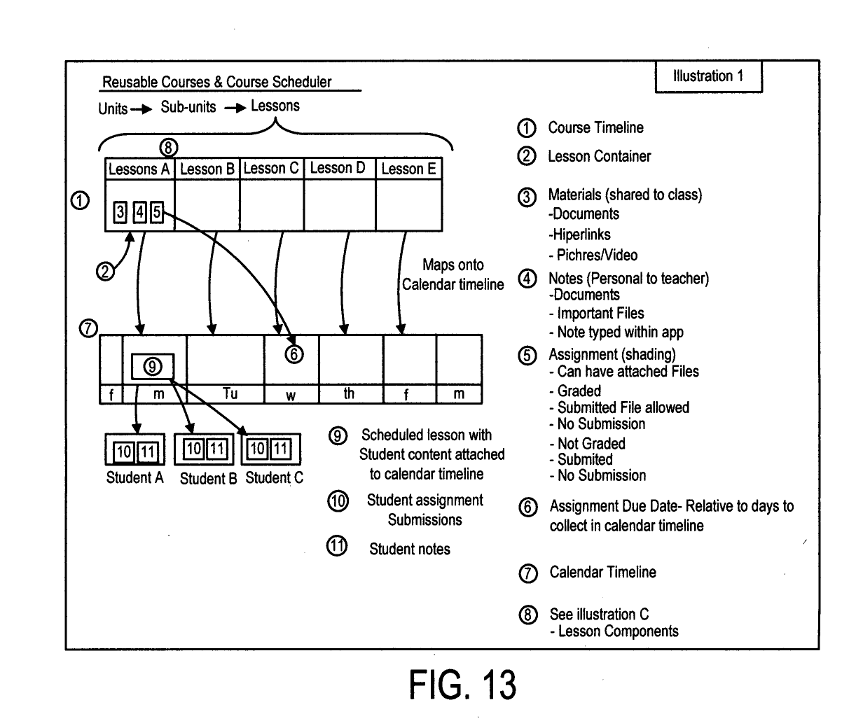

FIG. 13 further shows how the CLMS OMS is used to create such a personalized electronic study guide (ESG) for students. Through the OMS' framework of electronic Containers as shown in FIG. 12, through which all data is placed, timeline-accessible “daily” Lesson Containers are established for each day of a course curriculum. The Daily Containers are linked to the relevant Resources specific to the student and the Educational Activity for which the Student has a need for access to the Assets or Resources, referenced as Materials 3 in FIG. 12, relevant to the Activity. Each Asset is linked by the OMS to the one or more individual Containers to which they pertain. Both “shared” and “private” Resources and Assets are accessible by each student user. For example, when an Educator generates Course material available to the entire Class, the Educator attaches that shared material to the daily Containers to which its Timeline is relevant and it is accessible by all Class members taking the Course, e.g. up to the date of a Quiz, after which a different subject will be taught and that previous material is no longer relevant. The teacher may attach their own notes to the material, referenced as 4 in FIG. 12, that is only viewable to the teacher, and which are stored in their own container and attached to that material. Similarly, if a Student takes notes or conducts research relevant to the material taught during a lesson leading to Quiz A, referenced as 10 and 11 in FIG. 12, this Student-specific “private” data can be loaded to the ESG and will be linked to the relevant daily Containers only accessible to that Student, or to whomever the Student shares the material by granting specific other people their access such as to the teacher when the student makes their submission of the assignment.

For example, the Timeline functionality accesses Lesson Containers to populate a Student's ESG so that convenient and timely access to Resources needed to prepare for upcoming Educational Activities (various activities and tasks related to their Lessons, Courses, and overall educational curriculum) related to Courses they are taking can be made. Similarly, a User's calendar on the CLMS user interface (UI) is further organized such that what is upcoming in terms of assignments, tests, quizzes, projects for a set period of time can be viewed, for example in a “Coming Soon” component of the CLMS UI. In a further example, the Timeline allows Educators to schedule for a Course or curriculum by following a logical breakdown of what they will cover in a school learning period (trimester, semester, year) based on the content (e.g. Lessons taught, Resources accessed) and schedules set in prior years that doesn't typically change significantly from year to year. In essence, the Timeline together with the OMS and Workflow System effectively digitizes an Educator's curriculum map, the storage and filing system for Students, Educators and Administrators, and the organizational and planning system for all participants of the learning process. An Educator simply drags and drops the Lessons relevant to the Courses they are teaching, to the dates in their calendar. The relative date feature and settings of the Timeline (default or chosen by the Educator or Administrators) ensures Lessons that are placed in appropriate dates in the calendars, for example, skipping weekend dates. The designated material for which Students in Classes that are tied to the Lessons should have access then become available to those Students through the Scheduler and Electronic Study Guide, through the action of the Educator placing those Lesson(s) in the Timeline.

The electronic study guide accesses those Resources and Assets that relate to a Student's lesson plans, materials, handouts, assignments, submitted work, notes, and other information relevant to their Educational Activities. Each Asset is designated and stored in the OMS according to identifiers that have been assigned to that Asset pursuant to its relevance to a particular topic, course, Educator or other appropriate designation, so that each Resource can be effectively accessed by the ESG for a student specific presentation of each particular Educational Activity.

Given the reality of students' vast supply of curriculum Resources (including but not limited to their own materials, those publicly available, and those provided by the school), the potential for such an effective organization of Resources and Assets using traditional techniques for their organization is quite limited. This organization has largely been handled through manual efforts due to the complex need to coordinate so many resources with respect to the many schedules and timelines of various participants of the educational process including the Students, Educators and Administrators.

The ESG solves two main hurdles that are not currently being addressed in the prior art. The first is the capability to effectively search this wide variety of data sources, and the second is to coordinate the search results with the various timelines associated with the many Educational Activities pertaining to the Students' educational curriculum. A significant challenge for effective electronic organizing of a curriculum is filtering and organizing the Resources once they are accessed, with respect to different schedules and dates associated with multiple Educational Activities for which the relevant Resources need to be organized. These challenges to organizing, planning and preparing for Educational Activities are addressed by the ESG. The CLMS OMS and Timeline features are at the heart of the ESG's ability to offer a solution to these hurdles.

The student-personalized ESG accesses only those Resources in the OMS that are tagged or attributed to the particular Student and the relevant Educational Activity, such as the Students' own personal notes and materials added during the course or from past activities designated by the Student as relevant to a particular Course, as well as those shared Resources, such as course material, books and other resources relevant to the EA, provided by the Educator, Administrator or other CLMS User.

The ESG uses the OMS' simple data placement schemes and rich searchability features so that the system's algorithms and database can most effectively sort and place relevant information for convenient access. The ESG thus generates a useful guide for the student to easily find and present relevant materials at the micro-level, i.e. for an upcoming activity such as a homework assignment or test, and at the macro-level, i.e. for an entire course and curriculum, enabling more effective preparation and planning during the Educational Process.

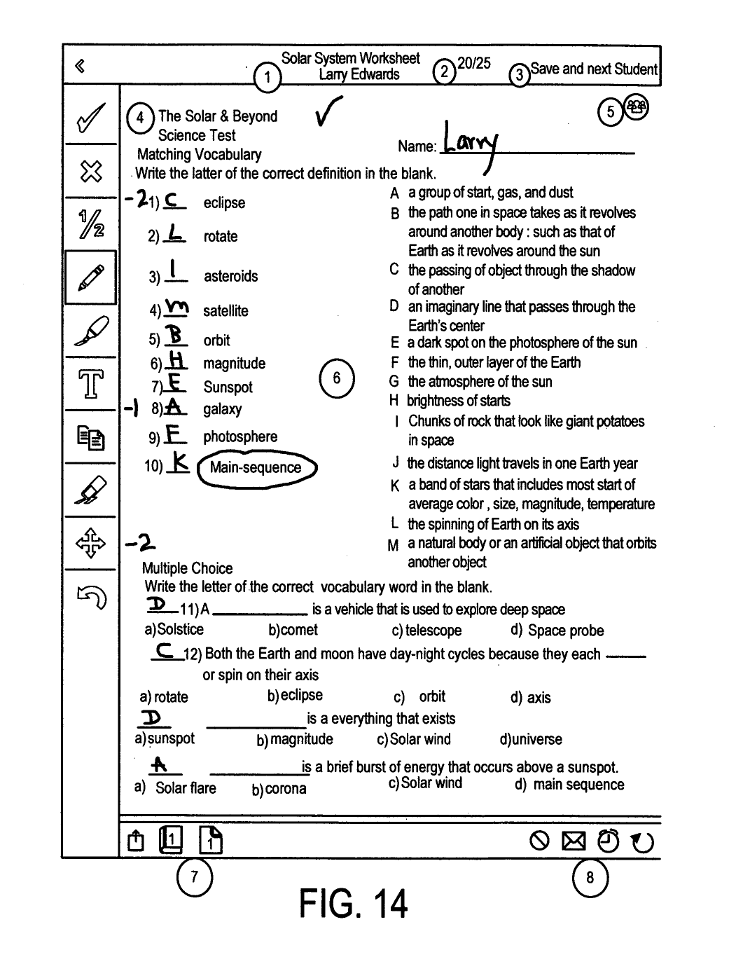

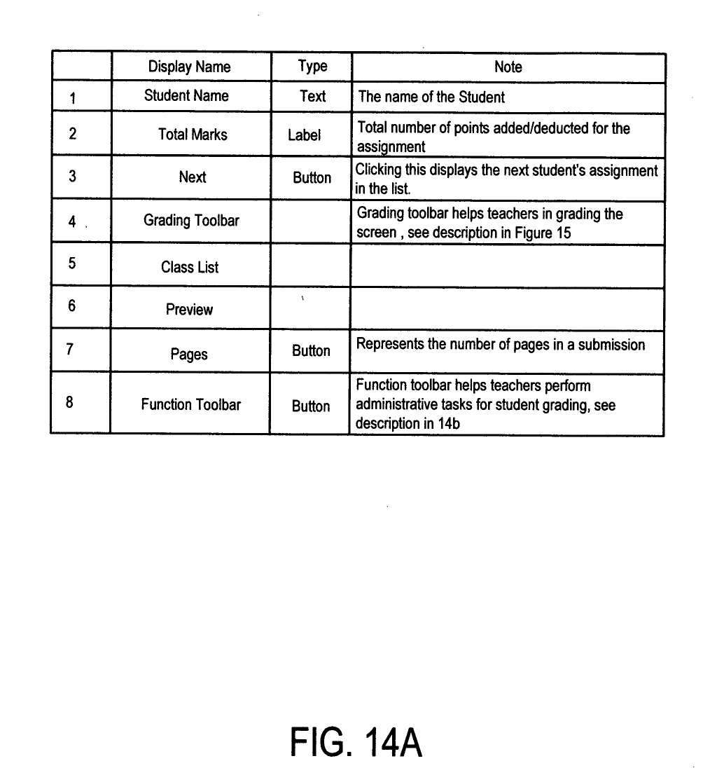

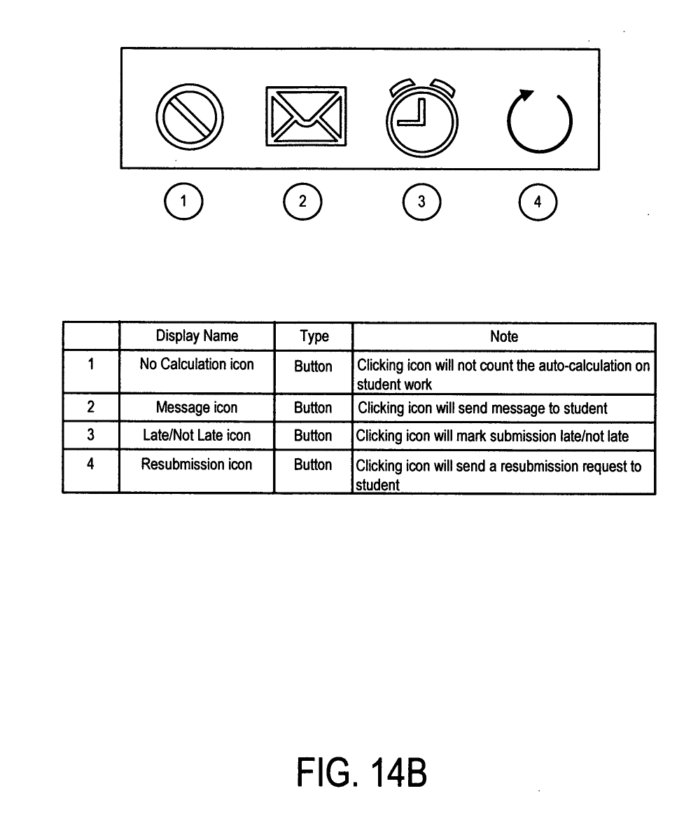

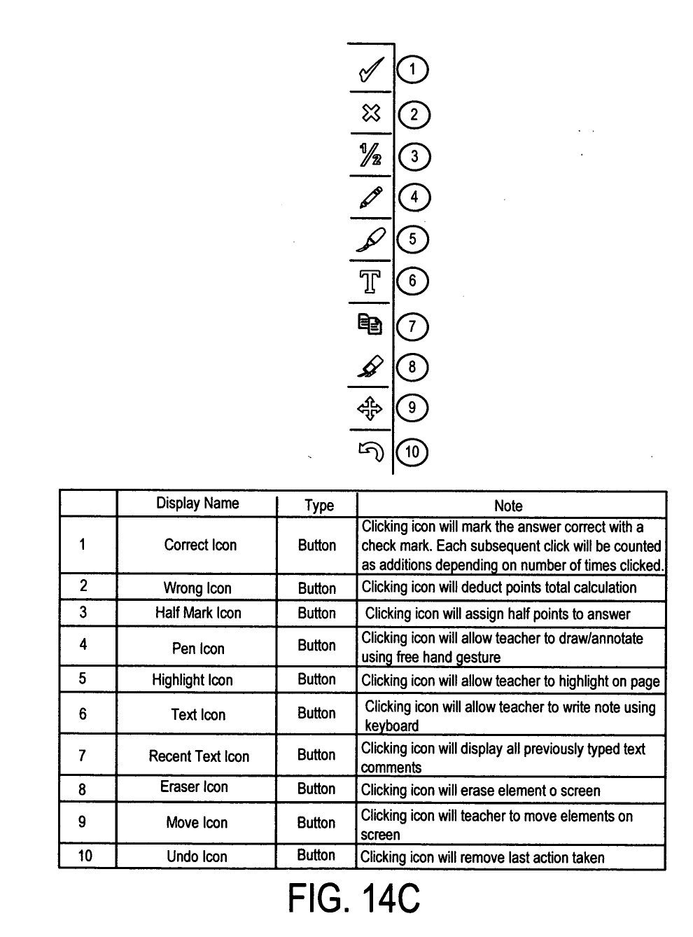

The challenge of scoping data to and from timelines according to Educational Activity and subject matter rather than requiring they be set by calendar date as in the prior art is addressed through the ESG. The timeframe that every Educational Activity related to a course takes place within a Curriculum Period is typically set by the Educator when creating the Course schedule or timeline, as referenced as 7 in FIG. 14, and/or by the Administrator when preparing the Course curriculum details. Once an Educator defines the scope of a Curriculum Period, including the timing for the tests, projects or other activities on a timeline for a relevant Course, a Student specific study guide is automatically constructed by the ESG that provides each participating Student with an organization of Resources and Assets linked to the Timeline of each associated activity for that Course.

The actual date(s), referenced as 6 in FIG. 12, that the data is loaded to the CLMS is not a critical factor to the ESG, nor is the date(s) of a scheduled activity, as the timelines of the ESG are conceptual and dynamic rather than limited to an actual date calendar. Schedule setting is thus based on the duration of the activities and relation of the Asset to the Educational Activity and the Resource to the Educational Curricula, rather than set definitely to a calendar. There is opportunity for adjustment of the activities through Administrator and Educator input, at any point in the scheduling process.

A Student seeking to access all their material relevant to an upcoming quiz can simply look to their personal ESG to find those Resources, greatly reducing the effort and complexity of such a task that previously has required a largely manual and complex effort. The conduciveness to disorganization and missed Resources from prior methods has been significantly alleviated through the automated ESG system and process that lends to a higher potential for organization and productivity. By restricting search results through resource identification in the OMS Containers, and by differentiating shared material from a user's private material, each student effectively has a personalized study guide which can be constructed dynamically based on the existence of an upcoming Educational Activity which that Student is involved, such as a course exam, whereby personalized search results for Resources relevant to the exam are presented to the Student.

Another innovative feature of the CLMS system integration is the application for electronic grading or scoring of a Student's work by an Educator. FIGS. 14, 14A, 14B and 14C illustrate the grading screen feature of the CLMS electronic grading tool “EGT” including the tool bar features.

The CLMS EGT performs an automated accounting of student activities during their educational curriculum, including individual grades for each Educational Activity and an accumulation and reporting of those grades to the Students' overall Course and curriculum scores. Alternatively, the individual grades could contribute to some other status ranking or posting for Students if a grading system other than numerical or alphabetical quantification is used to inform Parents and Administrators of a Students' progress.

A Student's work that is subject to grading by the Educator may include homework, a paper, project, report, test, exam, research or other assignment required or selected to be completed by the educational program's Educator or Administrator (referred to individually or collectively as a “Scoring Assignment”). The EGT allows for the Scoring Assignment to be submitted in either electronic or paper form and then converted to electronic form using an electronic conversion tool such as Open Office.

The CLMS EGT simplifies the process of scoring by offering a simple prompt at the outset of grading a new SA that allows the Educator to select from default settings of grading-related parameters. Settings include, for example, the amount of points to be given for each question, the total score for that SA, and the weight that the SA is to be given with respect to the overall class or curriculum.

An Educator can click on an Assignment title in a “To Be Graded” or other appropriately named component of their UI, leading the User to one or more of a group of Course Assignments submitted by the Students of a Class. Once an Educator grades a particular student's Assignment, the “To Be Graded” component's number displayed in the UI would decrease by 1. In addition that score would automatically be inserted into the Educator's gradebook within the CLMS. And once published those scores will be shared with the marked up and/or graded Assignment in the Students' scoring status component of the Student app or UI, and with the Parent of or Guardian to the Student (via the Parent app/UI).

The Educator may simply choose to click a pre-set scoring option at each grading point in the Scoring Assignment, for example as simple as a “✓” button for acknowledgement of a correct response, and a “x” button for an incorrect response. Once the Educator sets the overall total score of the Scoring Assignment, either based on the total number of individual items to be scored, or some other weighted allocation of grading parameters, the EGT smart grading tool uses an algorithm to either subtract a point for an incorrect answer, or take no action or optionally add bonus credit if the answer provided is correct. A running tally is displayed on the Educator UI, and a visual note may be displayed to alert the Educator at what point in the scoring process they have completed, e.g. 60% if 6 of 10 questions have been graded and four remain, and also when the scoring has been completed. If desired, multiple points can be added or deducted for a question or set of questions, if for example two points should be deducted for a question rather than just one, by clicking more than one time in a single spot. When the scoring process has been completed, the Educator selects a “Done” or “Next” button so that the student's Scoring Assignment may be recorded in the appropriate OMS database records for that Educator, Student, and Course.

The EGT may offer the user to choose from one or more selections of a rubric type template from one or more selections. Alternatively, the user may set new parameters for each setting. The default settings can be based on the user's last setting, or offered as a selection from a group of settings previously established.

Similar to the options available for scoring and weighting of an individual Scoring Assignment, a menu that allows the Educator to set weighting for the points of an individual Scoring Assignment, or for the individual SAs toward a Student's mid-term or final class score is offered. Alternatively, the EGT's default settings may be used. For example, for a Student's course, a rubric may be chosen from a selection of one or more templates offered in the EGT settings menu that are relevant to a topic or curriculum, or a template with a formula for weighting individual Scoring Assignments relative to all the Scoring Assignments for a course may be set by the Educator or Administrator, e.g. 3 quizzes are each worth 10% of an overall course grade, a paper is worth 20%, and final exam is worth 50% to make up 100% of a Student's maximum overall course grade.

In addition to an accounting of the individual Scoring Assignments with respect to the overall Student's course grade, the CLMS EGT accounts the Student's overall curriculum grade status reflecting all relevant course grades and other relevant activity for that curriculum period/CP and for the Student's entire tenure at the academic institution. This scoring process greatly simplifies what has previously been a multiple step, manual process for grading, tallying and accounting.

As shown in FIG. 14, this illustrative screen shows a user screen of the electronic grading tool. Reference to 1 is the student's name. Reference to 2 is the number of points available for the assignment and the student score for an assignment. In some embodiments all student scores start with having full credit for the assignment and proceed to add or deduct points with the auto-calculation feature. As points are calculated by clicking on the screen using the correct or deduction button the total number of points are auto-calculated for the student. This eliminates the need for teachers to manually count the number of additions or deductions for student work. Reference to 3 is the button that saves the work to the included grade book and moves on to the next student in the list. Reference to 4 is the grading toolbar, further described with reference to FIG. 14C. Reference to 5 is the button that when clicked opens a side panel that displays the students in the list of assignments to grade and if previously graded will also display the student score. Reference to 6 is an example of screenshot of student work with annotations including deductions, check marks, pen marks, text and highlighting. Reference to 7 displays the total number of student submissions with the number of pages for each submission. In this example, there is one submission with one page. Reference to 8 are the buttons that perform additional administrative tasks that a teacher might need when grading student work, see embodiment FIG. 14B.

As shown in FIG. 14B, this screen shows a detailed view of the electronic grading tool administrative tasks in FIG. 14. Reference to 1 on FIG. 14 is the no calculation button. When this button is clicked a teacher can choose to have the auto-calculation be inactive for the student score. If selected, the teacher can press again to have the auto-calculation become active again. Reference to 2 is the message button. A teacher can press this button to send a message to the active student they are grading in the grading tool. Reference to 3 is the Late/Not Late button. Clicking this button marks the student work late. If already selected the teacher can press button to mark the student work not late. Reference to 4 is the resubmission button. When this button is clicked the student would receive a notification that they need to resubmit the work. In some embodiments there are default reasons, such as “Wrong Assignment”, “Incomplete Work”, and an empty text box for teacher to put in any other type of resubmit reason.

As shown in FIG. 14C, this screen shows a detailed view of the grading toolbar in FIG. 13. Reference to 1 is the correct button; this is also called the check mark and additions button. Upon clicking this button, a teacher can press on the submitted work and a check mark will first appear and not add or deduct points from the total points of the assignment. A second click on the submitted work will add one point to the total points for the student; every subsequent click would add an additional point. Reference to 2 is the deduction or wrong button. Upon clicking this button, a teacher can press on the submitted work and a “−1” will first appear and deduct one point from the student total points of the assignment; every subsequent click would deduct an additional point. Reference to 3 is the half mark button. When selecting this button in addition to the correct or wrong icon a half mark will be added to the addition or deduction. Reference to 4 is the pen button. When selecting this button and touching the screen will allow teacher to free write on the student work. Reference to 5 is the highlighting button. When selecting this button and touching the screen will allow teacher to highlight on the student work. Reference to 6 is the text button. When selecting this button and clicking on the screen a teacher can write on the student work using a keyboard. Reference to 7 is the recent text button where upon being clicked opens a side panel that displays all the recently used text/phrases for the assignment and for the class. For a given assignment and class the text already used for one student would be available to quickly add on the next student work. Reference to 8 is the eraser button that allows a teacher to erase teacher created annotations on the student work. Reference to 9 is the move button that allows a teacher to move any teacher created annotation to another portion of the student work on the screen. Reference to 10 is the undo icon that allows a teacher to undo the last action taken on the student work by the teacher.

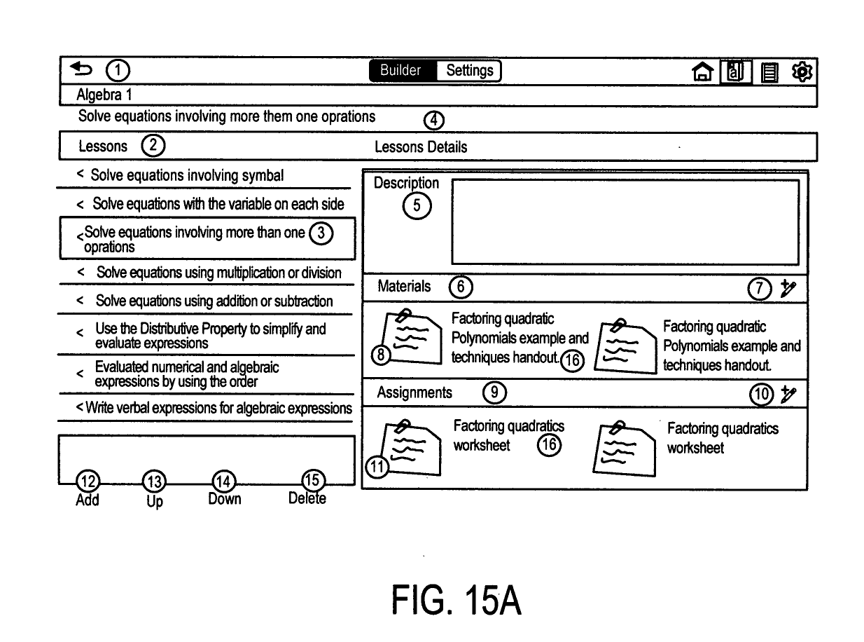

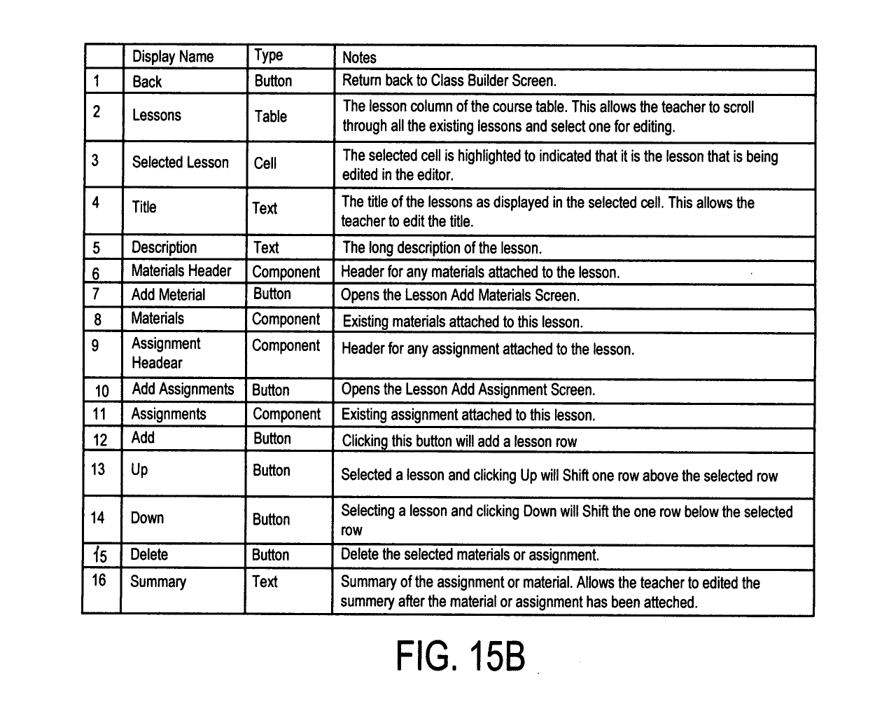

FIGS. 15A and 15B is an example screen and description of the Class Builder Assignment Editor feature of the Reusable Class System (RCS) in accordance of some embodiments of the present invention. The RCS innovation of the CLMS is the facilitated organization and preparation of Courses and related Assets, e.g. materials such as lesson plans, homework assignments and tests, using the system of containers described herein.

Preparing for lessons, courses and curriculum requires an Educator or Administrator to recall what materials have been used in the past for similar matters by relying on the current or former personnel's or school administrative manual and/or electronic filing systems, and when useful, the personal memories of the Educator or Administrator previously involved in the matter(s). Once recalled, the Educator then must review and sort those materials they wish to reuse, and update them accordingly with new information and materials. This is a particularly burdensome and heavily manual process.

In the electronic realm, a collection of materials is put in a folder or a set of folders for the Educator to sort for reuse. Certain of the materials will be exposed to the students in the class once they have been reviewed and updated by the Educator and determined which are appropriate for what section of the Course. The burden is on the Educator to name, organize and file the materials so that they will be properly accessed for the appropriate Class or Lesson at the necessary section of the Course. The burden is even greater to access certain materials when it would be useful to cross reference in a different section of the Course or for another Class in the same or a different curriculum to which that material has relevance. Although the materials are digitally stored, the process is susceptible to the same problems as paper storage of materials in that the hassles of organizing, updating and properly referencing and accessing them to match the most effective courses remains largely manual. Creating the structure for the organization and administration of the materials (Resources and Assets) is the responsibility of the Educator or Administrator and due to the inherent complexity of the process as described herein, the process has not yet been effectively transferred to the electronic realm for increased process efficiency. Further, the process of creating assignments and tests from the existing resources is not easily automated from year to year. These problems are largely overcome through Applicants' invention of the CLMS Reusable Course System (RCS).

A typical Course amounts to about 60 to 180 Lessons throughout a Learning Period, however it is understood that the nature of educational courses vary widely and thus any particular Course could comprise a fewer or greater number of Lessons. Consequently, a lot of Assets must be managed for each Course. Several components of the CLMS make up the RCS to significantly ease the burden of Asset management by Educators and Administrators, resulting in more time available for the Educator to focus on the more substantive and useful parts of the educational process such as researching new and updated content for the course, and educating and assisting students to most effectively succeed in the course and within the academic program.

Smart Scheduler

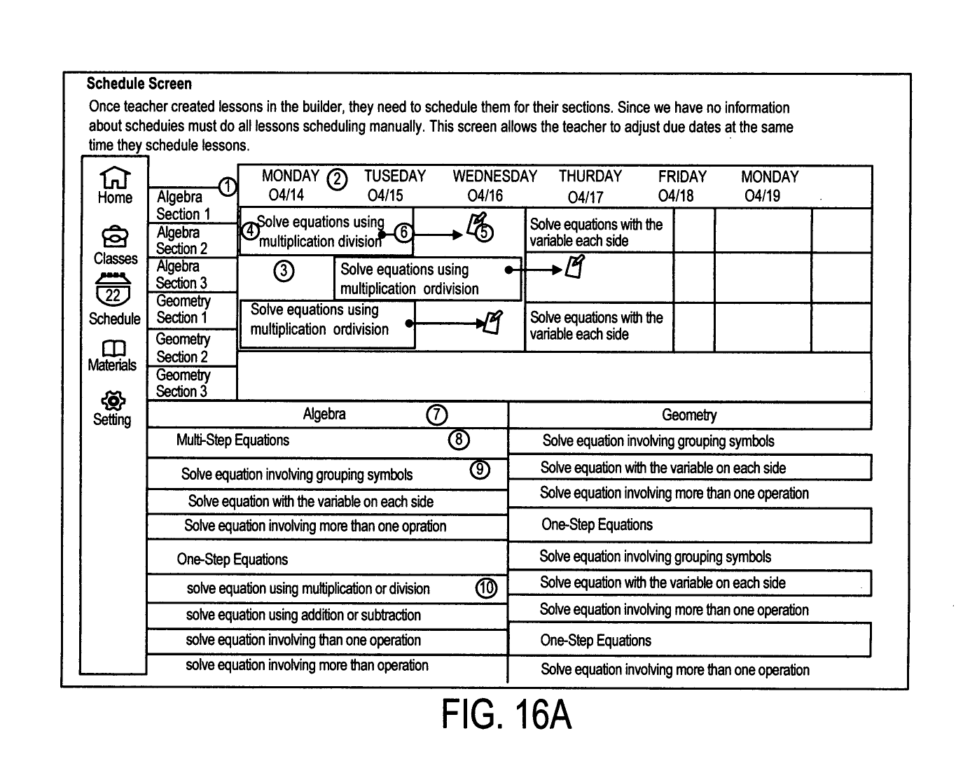

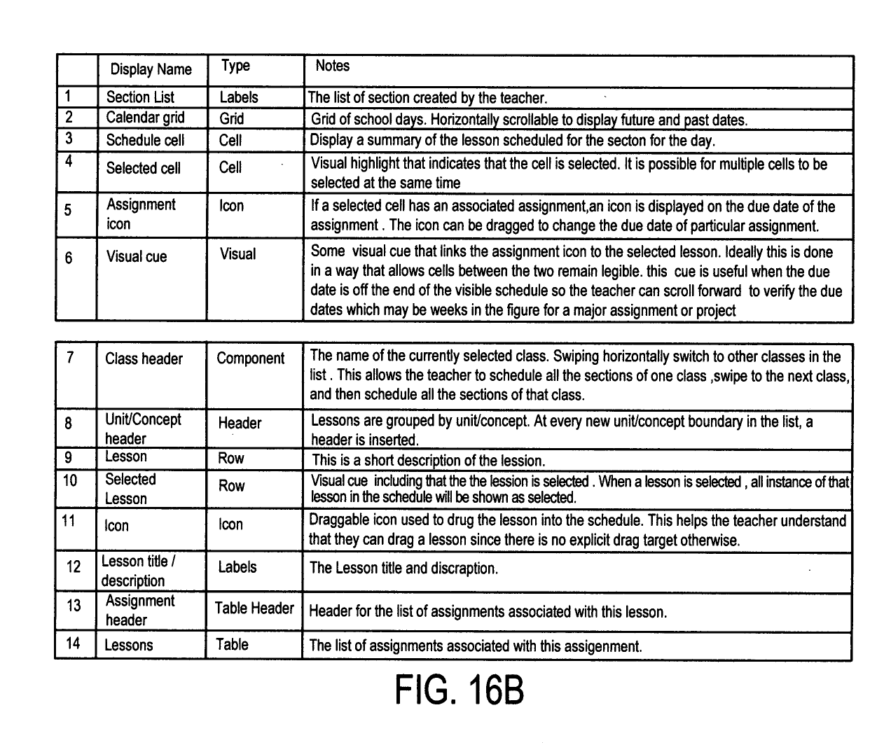

Yet another innovative feature of the CLMS is the automated “smart” scheduling of tasks related to the Educational Process (EP), including projects, assignments, events and tests referred to during a Learning Period (class, semester or curriculum period) through the CLMS Smart Scheduler. FIG. 16A and FIG. 16B is an example screenshot and description of the Schedule Screen feature of the Smart Scheduler in accordance of some embodiments of the present invention.

Coordinating the scheduling of the many various activities of each Course within a Learning Period is another administrative burden for Educators and Administrators, which to date is inherent with opportunities for error and complexity. Many Educators are required to construct lesson plans well in advance of their implementation date during the Learning Period (class or curriculum period). Lesson plans typically require a substantial amount of coordination and preparation of various aspects related to the Course besides the specific subject matter to be presented by the Educator, including related resource materials, homework assignments, papers and tests to be assigned to students. In the prior art, it has been necessary for the Educator to be aware of which materials (Resources and Assets) need to be made available or visible to students over the course of the upcoming week or other planning period and enable them as required. If there are assignments due, the Educator needs to create them, assign due dates, coordinate them with other class activities such as exams, and also make them visible to students at the appropriate times. These are construction tasks for the Educator, and are marked by the need for many manual tasks including the evaluation of existing content, remembering dates, constructing content, and performing tasks over time to reveal the content at the correct time(s).

The CLMS Smart Scheduler offers greater ease and precision to Educators and Administrators for coordinating the scheduling needed during the EP, which to date has been largely a process of construction and thus a significant burden. The CLMS Smart Scheduler provides a visual tool with obvious prompts for the user to acknowledge. The foundational OMS (organizational management system) and Timeline facilitate the electronic coordination of these tasks.

Once an Educator identifies a scheduling task such as an Educational Activity related to a curriculum, Course or Lesson for which it is scheduling, the OMS feeds the Smart Scheduler with all associated Assets and Resources e.g. Lesson Containers, and consequently the CLMS alerts the Educator or Administrator with a number of prompts via the Smart Scheduler. The Smart Scheduler ties into the Timeline and OMS system and its organizational structure and offers the User prompts to accept or modify, such as acknowledging an upcoming Educational Activity, assigning the number of days for its completion by Students, and responding to other relevant targeted questions or suggestions based on tags and other Resources designated in the OMS Containers associated with that EA. For example, a prompt automated by the Smart Scheduler may be to suggest Lessons to be dragged and dropped into a Timeline for a Course, and to request the Educator to fill in the number of days to be assigned for particular Educational Activities such as homework, or the number of days desired between exams or assignments.

A number of default settings can be modified as the user designates. The Smart Scheduler also may be set to an ‘intuitive learning’ setting to “learn” the level of detail that a user prefers and adjust Smart Scheduler settings accordingly, and sets the level of prompt detail accordingly, which can be adjusted by the user at any time. For example, a Smart Scheduler default setting may be that only Lessons designated as current or active will appear. However, a user may wish to view Lessons that have been designated as obsolete or inactive that are also tied to a particular Lesson or Course in the OMS, as he/she may be searching for content to edit the Course from the most recent content or to create a new Course. For example, a setting that an Educator may choose for lesson planning may be to include weekend calendar days to count for time allowed for students to complete homework assignment tasks, but not count weekend days for lesson scheduling. This type of setting feature is available through the Smart Scheduler to establish new default settings or temporary overrides of existing settings.

Prompts appear both outside the scheduling screen and while on the scheduling screen to guide the user to optimize curriculum organization and scheduling. For example, a prompt may appear while the user is within the Smart Scheduler performing scheduling activities that suggest that the user consider scheduling for the next Lesson in the Course, or next Course in the Timeline. The user may opt to postpone such next scheduling activity by simply clicking the equivalent of a “skip”, “not now” or “ask me in an hour/day” button, in which case at a preset period of later time, the upcoming scheduling item such as a next Lesson or exam, will show up again as a prompt. A message may also appear on the UI outside the Smart Scheduler feature, e.g. on the user's Home screen or other page, that may guide the user to consider an upcoming EA it has scheduled, and to provide the user the opportunity to access the Assets it has associated with that Educational Activity. The goal of the OMS and Smart Scheduler is to tag and organize each Asset in an Educator's Educational Program so that the process for scheduling and organizing is as seamless as possible, freeing up the Educator's time for more value-added activity such as research, presentation, and assisting the students, and making the Educational Program as simple as possible for students to focus on learning rather than organizing.

Once lessons, assignments and other related Educational Activities are set onto a Timeline, the Educator can easily view them on the UI/CLMS app for verification as they are displayed on a date calendar. If there are no date changes needed, the scheduling process is completed for that Educational Activity. If there is an adjustment that is needed or desired, e.g. the Educator prefers that an assignment not fall on a Friday, they may simply drag that activity to another date in the calendar and activities associated with that Educational Activity will be automatically adjusted accordingly through the Timeline.

The Smart Scheduler features the ability to track the due dates for assignments or EAs given to students. The Smart Scheduler uses the CLMS Timeline to treat all dates as relative and not calendar date specific. When planning for Courses and a Curriculum Period overall, the Educator simply specifies the number of days of effort required for each related Educational Activity. This obviates the need for the Educator or Administrator to compute due dates based on the actual date of assignment or otherwise associated with a date calendar; the assignment due date can be automatically computed by the system's Smart Scheduler and presented to the Student on their date calendar display. It also facilitates the coordination of all Assets and EAs related to the scheduling required for a Curriculum Period, as the OMS Containers presents a system for tying all related Assets together and simplifying the process for recalling the appropriate materials and activities needed for such scheduling and planning. The visual display of the Timeline and CG allows for easy manipulation of information, e.g. the Educator can drag and drop a homework assignment that falls on a Friday due to its relative date designation, and move it to Monday so as to avoid the weekend.

The Smart Scheduler makes the process of organizing curriculum and course activities an exercise of verification, and reduces the burden of construction-oriented tasks.

Detailed illustrative embodiments of the CLMS are disclosed herein. An overview of the CLMS features that have been described herein is included in FIG. 17.

However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it m is ay be more convenient to construct a more specialized apparatus to perform the required operations.

The embodiments can also be embodied as computer readable code on a computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described him operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of automating student and teacher workflow among a class of multiple students, comprising:
initiating, from a teacher-operated computing device, distribution of a class assignment data to multiple student-operated computing devices;
receiving, at a database, from the multiple student-operated computing devices, student-provided assignment data, wherein the student-provided assignment data is accessible at the database by the teacher-operated computing device; and
processing an evaluation by the teacher-operated device of the student-provided assignment data by a computer processor, wherein a grade for the evaluation of the assignment data for each of the multiple student-operated computing devices is further processed to organize the assignment data with regard to each student and among the multiple students in the class.

2. The method of claim 1, further comprising:
tracking, from the teacher-operated computing device coupled to the database, the class assignment data that has been received; and
further tracking, from the teacher-operated computing device, the class assignment data that has been evaluated, from the multiple student-operated computing devices among the class of multiple students.

3. A system for electronically enabling efficiency in an educational environment, comprising:
a database;
a server coupled to the database, the server configured to:
couple to at least one teacher-operated computing device;
couple to multiple student-operated computing devices;
provide a class assignment data to the multiple student-operated computing devices;
receive, from at least one of the multiple student-operated computing devices, student-provided assignment data;
provide, to the teacher-operated computing device, via the database, access to the student-provided assignment data;
receive, from the teacher-operated computing device, an evaluation of each of the student-provided assignment data received; and
provide, to the multiple student-operated computing devices, via the database, read-only access to the evaluation of the student-provided assignment data; and
a processor coupled to the server, the processor configured to organize the evaluations of each of the student-provided assignment data received for each student in a class and with respect to each other student in the class.

4. The system of claim 3, further comprising:
a tracking device, to notify the teacher-operated computing device that the class assignment data that has been received by one or more students in a class.

5. The system of claim 4, wherein the tracking device further tracks, from the database, the class assignment data that has been evaluated, from the multiple student-operated computing devices among the class of multiple students.
